(19) United States
(12) Patent Application Publication
(10) Pub. No.: US 2018/0067273 A1
(43) Pub. Date: Mar. 8, 2018

(54) PLANAR TAPERED WAVEGUIDE COUPLING ELEMENTS AND OPTICAL COUPLINGS FOR PHOTONIC CIRCUITS

(71) Applicant: CORNING OPTICAL COMMUNICATIONS LLC, Hickory, NC (US)

(72) Inventors: Ying Geng, Bellevue, WA (US); Ming-Jun Li, Horseheads, NY (US); James Phillip Luther, Hickory, NC (US); Jerald Lee Overcash, China Grove, NC (US)

(21) Appl. No.: 15/812,398

(22) Filed: Nov. 14, 2017

Related U.S. Application Data
(63) Continuation of application No. PCT/US16/33424, filed on May 20, 2016.
(60) Provisional application No. 62/168,316, filed on May 29, 2015.

(51) Int. Cl. G02B 6/42; G02B 6/122; G02B 6/02; F21V 8/00

(52) U.S. Cl. CPC G02B 6/4246; G02B 6/0011; G02B 6/02047; G02B 6/1228

(57) ABSTRACT

An optical coupling includes a planar tapered waveguide coupling element having a first end opposite a second end, a tapered waveguide positioned within a planar substrate, the tapered waveguide comprising a waveguide diameter that is larger at the first end than at the second end. An optical pathway is disposed within the tapered waveguide and extends between the first end and the second end. The tapered waveguide is tapered from the first end to the second end such that the waveguide diameter transitions a light beam traveling along the optical pathway from a first beam size at the first end to a second beam size at the second end.

### PRIORITY APPLICATIONS

This application is a continuation of International Application No. PCT/US16/33424, filed on May 20, 2016, which claims the benefit of priority to U.S. Application No. 62/168,316, filed on May 29, 2015, both applications being incorporated herein by reference.

### TECHNICAL FIELD

The present specification relates to optical coupling devices for coupling a light source to a receiving fiber.

### BACKGROUND

Silicon photonic (SiP) transceivers offer high data rates, compact size, high port density and low power consumption, and are therefore useful in data center applications. Single mode or small core, multimode optical fiber is desired in these applications because it can support high bandwidths. Currently, it is difficult to couple a SiP laser to an optical fiber at low cost. Further, it is difficult to couple small mode field light sources having a high numerical aperture with a single mode or a small core multimode fiber.

Accordingly, there is a desire for improved coupling devices that can couple a laser module to small core multimode or single mode fiber.

### SUMMARY

In one embodiment, an optical coupling device includes a planar tapered waveguide coupling element having a tapered waveguide positioned within a planar substrate having a first end opposite a second end. The tapered waveguide includes a waveguide diameter that is larger at the first end than at the second end. An optical pathway is located within the tapered waveguide and extends between the first end and the second end. The tapered waveguide is tapered from the first end to the second end such that the waveguide diameter transitions a light beam traveling along the optical pathway from a first beam size at the first end to a second beam size at the second end.

In another embodiment, an optical coupling for a photonics circuit includes a light source optically coupled to a planar tapered waveguide coupling element. The light source is configured to generate a light beam. A lens system is disposed within an optical pathway between the light source and the first end of the planar tapered waveguide coupling element. The planar tapered waveguide coupling element includes a tapered waveguide positioned within a planar substrate having a first end opposite a second end. The light source is optically coupled to the first end and the tapered waveguide includes a waveguide diameter that is larger at the first end than at the second end. The optical pathway is located within the tapered waveguide and extends between the first end and the second end. The tapered waveguide is tapered from the first end to the second end such that the waveguide diameter transitions the light beam traveling along the optical pathway from a first beam size at the first end to a second beam size at the second end. Further, a receiving fiber is optically coupled to the second end of the planar tapered waveguide coupling element.

In yet another embodiment, an optical coupling for a photonics circuit include a connector body and a planar tapered waveguide coupling element positioned within the connector body. The planar tapered waveguide coupling element includes one or more tapered waveguides positioned within a planar substrate having a first end opposite a second end. The one or more tapered waveguides each include a waveguide diameter that is larger at the first end than at the second end. An optical pathway is located within each of the one or more tapered waveguides and extending between the first end and the second end. The one or more tapered waveguides are tapered from the first end to the second end such that each waveguide diameter transitions a light beam traveling along the optical pathway from a first beam size at the first end to a second beam size at the second end. These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an exemplary optical coupling having a planar tapered waveguide coupling element according to one or more embodiments described herein;

FIG. 2 depicts a graph measuring spatial offset tolerance vs. expanded beam size for a planar tapered waveguide coupling element according to one or more embodiments described herein;

FIG. 3 depicts a graph measuring angular offset tolerance vs. expanded beam size for a planar tapered waveguide coupling element according to one or more embodiments described herein;

FIG. 4 depicts a graph measuring the mode field diameter change as a function of waveguide diameter of a planar tapered waveguide coupling element according to one or more embodiments described herein;

FIG. 5 schematically depicts another exemplary optical coupling having another example planar tapered waveguide coupling element according to one or more embodiments described herein;

FIG. 6 schematically depicts a graph measuring the mode field diameter change as a function of waveguide diameter of the planar tapered waveguide coupling element of FIG. 5 according to one or more embodiments described herein;

FIG. 7A schematically depicts a masking step of an ion exchange process of fabricating an exemplary planar tapered waveguide coupling element according to one or more embodiments described herein;

FIG. 7B schematically depicts a photolithography step of the ion exchange process of fabricating an exemplary planar tapered waveguide coupling element of FIG. 7A according to one or more embodiments described herein;

FIG. 7C schematically depicts a molten salt bath step of the ion exchange process of fabricating an exemplary planar tapered waveguide coupling element of FIGS. 7A and 7B according to one or more embodiments described herein;

FIG. 8 schematically depicts a laser inscription process of fabricating an exemplary the planar tapered waveguide coupling element according to one or more embodiments described herein;

FIG. 9A depicts a schematic view of an exemplary optical coupling having a tapered coupling element according to one or more embodiments described herein;

FIG. 9B depicts a schematic view of another exemplary optical coupling having a tapered coupling element according to one or more embodiments described herein;

FIG. 9C depicts a schematic view of an exemplary optical coupling having a tapered coupling element and a GRIN lens according to one or more embodiments described herein;

FIG. 9D depicts a schematic view of an exemplary optical coupling having a tapered coupling element and a reverse tapered coupling element according to one or more embodiments described herein;

FIG. 10A depicts a schematic view of an exemplary light source connector according to one or more embodiments described herein;

FIG. 10B depicts a schematic view of an exemplary light source connector using a waveguide incorporating a grating according to one or more embodiments described herein;

FIG. 10C depicts a schematic view of an exemplary light source connector using a tapered waveguide having an angled endface according to one or more embodiments described herein;

FIG. 11 depicts an isometric view of an exemplary molded optical coupling having a planar tapered waveguide coupling element according to one or more embodiments described herein;

FIG. 12 depicts an exploded view of the exemplary molded optical coupling of FIG. 11 according to one or more embodiments described herein;

FIG. 13 depicts a sectional view of the exemplary molded optical coupling of FIG. 11 according to one or more embodiments described herein;

FIG. 14 depicts an isometric view of another exemplary molded optical coupling having a planar tapered waveguide coupling element according to one or more embodiments described herein;

FIG. 15 depicts an exploded view of the exemplary molded optical coupling of FIG. 14 according to one or more embodiments described herein;

FIG. 16 depicts another exploded view of the exemplary molded optical coupling of FIG. 14 according to one or more embodiments described herein;

FIG. 17 depicts a schematic view of an optical coupling having a plurality of planar tapered waveguide coupling elements optically coupled to a host glass according to one or more embodiments described herein; and

FIG. 18 depicts a partial, sectional view of the optical coupling of FIG. 17 according to one or more of the embodiments described herein.

### DETAILED DESCRIPTION

Embodiments of the present disclosure are directed to optical couplings comprising a planar tapered waveguide coupling element for optically coupling a light source and a receiving fiber (e.g., a single mode or a small core multimode optical fiber). The planar tapered waveguide coupling element may comprise one or more tapered waveguides positioned within a planar substrate, for example, an array of tapered waveguides positioned within an individual planar substrate. The one or more tapered waveguides are tapered from a first end to a second end. The first end may be optically coupled to the light source and the second end may be optically coupled to the receiving fiber. The light source produces a light beam, such as a laser beam, and the receiving fiber may receive the light beam. The optical couplings disclosed herein provide a device to transform the light beam distribution of the light source to match the light beam distribution of the receiving fiber, including at least a planar tapered waveguide coupling element. An alignment tolerance of the optical coupling enables passive alignment, for example, the optical coupling may provide a large offset alignment tolerance. Further, the planar tapered waveguide coupling element may not require the light source to be precision aligned to the receiving fiber, facilitating field installation. Additionally, the optical couplings may comprise various molded optical coupling assemblies that house a planar tapered waveguide coupling elements having an array of planar waveguides positioned within a planar substrate to optically couple an array of receiving fibers with a photonics integrated circuit, for example, a silicon photonics integrated circuit.

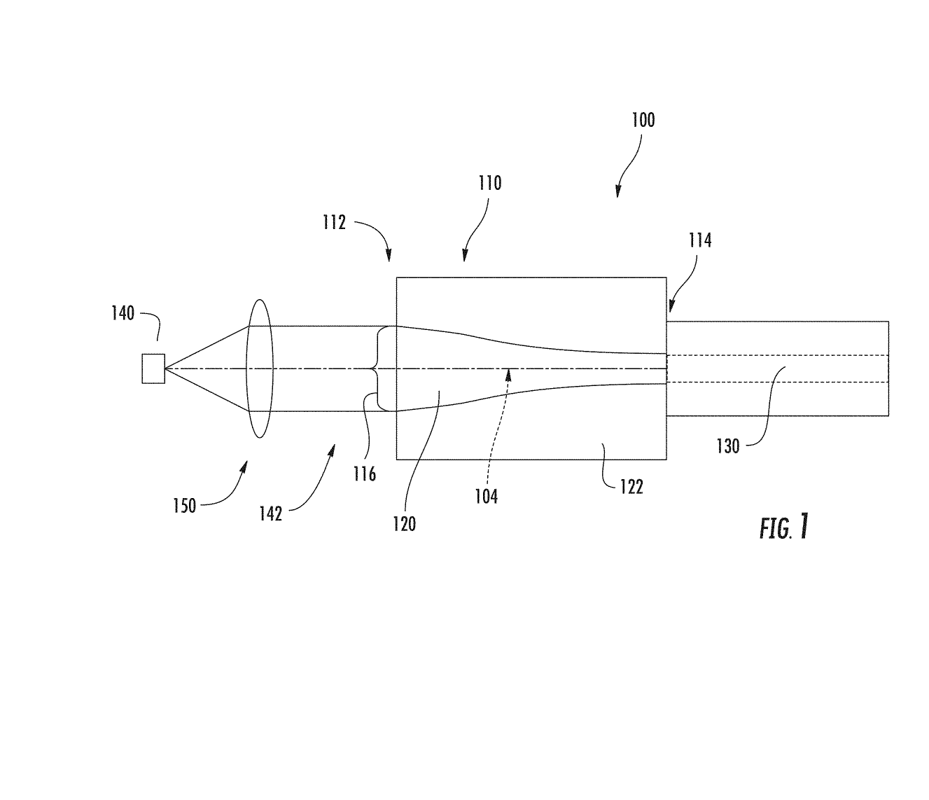

Referring now to FIG. 1, a schematic view of an exemplary optical coupling 100 for a photonics circuit is depicted. The optical coupling 100 comprises a planar tapered waveguide coupling element 110 that is monolithic and comprises a tapered waveguide 120 and a planar substrate 122. The tapered waveguide 120 may be positioned within the planar substrate 122. The tapered waveguide 120 is tapered from a larger first end 112 to a smaller second end 114 having taper shape that is linear, non-linear, exponential, half-Gaussian, s-shaped, or a combination thereof. In alternative embodiments, the tapered waveguide 120 may be reversed such that the first end 112 is smaller than the second end 114. The planar tapered waveguide coupling element 110 is positioned along an optical pathway 104 between a light source 140 and a receiving fiber 130, optically coupling the light source 140 and the receiving element 130 such that the optical pathway 104 traverses the planar tapered waveguide coupling element 110. In some embodiments, the optical coupling 100 may include multiple planar tapered waveguide coupling elements 110. Additionally, an individual planar tapered waveguide coupling element 110 may comprise an individual planar substrate 122 and an array of tapered waveguides 120 positioned within the individual planar substrate 122.

Referring still to FIG. 1, the tapered waveguide 120 and planar substrate 122 of the planar tapered waveguide coupling element 110 of FIG. 1 are schematically depicted. The planar substrate 122 may comprise a plastic, polymer, glass (e.g., silica based glass), or the like. The tapered waveguide 120 may also comprise a plastic, polymer, glass or the like, and, in some embodiments may comprise a material having a higher refractive index than the planar substrate 122. In some embodiments, the tapered waveguide 120 and the planar substrate 122 may comprise different materials (e.g, a polymer tapered waveguide 120 on glass planar substrate 122). The tapered waveguide 120 comprises a waveguide diameter 116 that tapers such that the waveguide diameter 116 is larger at the first end 112 than the second end 114. In some embodiments, the tapered waveguide 120 comprises a circular cross-section. In other embodiments, the tapered waveguide 120 comprises a non-circular cross-section, for example, an oval cross-section, an elliptical cross-section, or the like. In this embodiment, the tapered waveguide 120 comprises a short waveguide diameter (e.g., the waveguide diameter measured along a minor axis of the non-circular cross section) and a long waveguide diameter (e.g., the waveguide diameter measured along a major axis of the non-circular cross section). In these embodiments, the waveguide diameter 116 may be an average waveguide diameter 116 comprising an average of cross section measurements of waveguide diameter of the tapered waveguide 116. It should be understood that any discussion of waveguide diameter 116 herein may refer to tapered waveguides 120 comprising circular or non-circular cross sections shapes comprising average waveguide diameters 116.

The planar substrate 122 may comprise any shape, for example, a generally rectangular shape, square shape, oval shape, or any shape sufficient to support the tapered waveguide 120 positioned within the planar substrate 122. The planar substrate 122 may comprise any width to support any number of tapered waveguides 120 positioned within the planar substrate 122. Further, the planar substrate 122 comprises a substrate height that is larger than the waveguide diameter 116 of the second end 114 (i.e. larger than the largest waveguide diameter the tapered waveguide 120) such that some material of the planar substrate 122 surrounds the tapered waveguide 120. In some embodiments, the planar tapered waveguide coupling element 110 may comprise an array of tapered waveguides 120.

Referring again to FIG. 1, the light source 140 may comprise a SiP laser, VCSEL laser, or another type of semiconductor laser. For example, light source 140 may comprise a photonics integrated circuit, for example a silicon photonics integrated circuit, or the like. The light source 140 is optically coupled to the first end 112 of the planar tapered waveguide coupling element 110. The light source 140 emits the light beam 142 that travels along the optical pathway 104 into the first end 112 of the planar tapered waveguide coupling element 110. In some embodiments, a lens system 150 is positioned within the optical pathway 104 between the light source 140 and the first end 112 of the planar tapered waveguide coupling element 110. The lens system 150 may expand and/or alter the light beam 142, for example, using a collimating lens to collimate and enlarge the optical field distribution of the light beam 142. In operation, once the light beam 142 passes through the lens system 150, it is directed into the planar tapered waveguide coupling element 110. In some embodiments, the diameter of the lens system 150 is substantially equivalent to, or less than, the waveguide diameter 116 at the first end 112 of the planar tapered waveguide coupling element 110, and a numerical aperture of the lens system 150 may be substantially equivalent to or less than a numerical aperture at the second end 114 of the planar tapered waveguide coupling element 110 (defined as sine, where e is the beam divergence angle), such that a substantial portion of the optical field distribution of the light beam 142 with a first beam size may enter the tapered waveguide 120 of the planar tapered waveguide coupling element 110 and is transferred to a second beam size through the tapered waveguide 120.

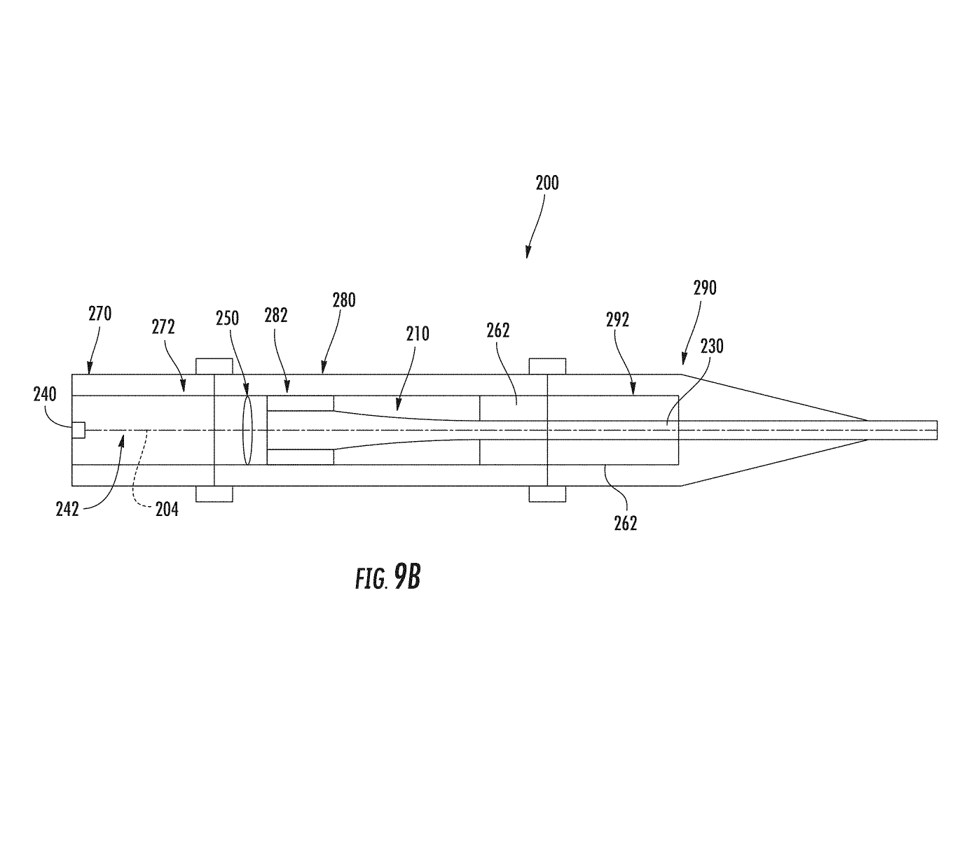

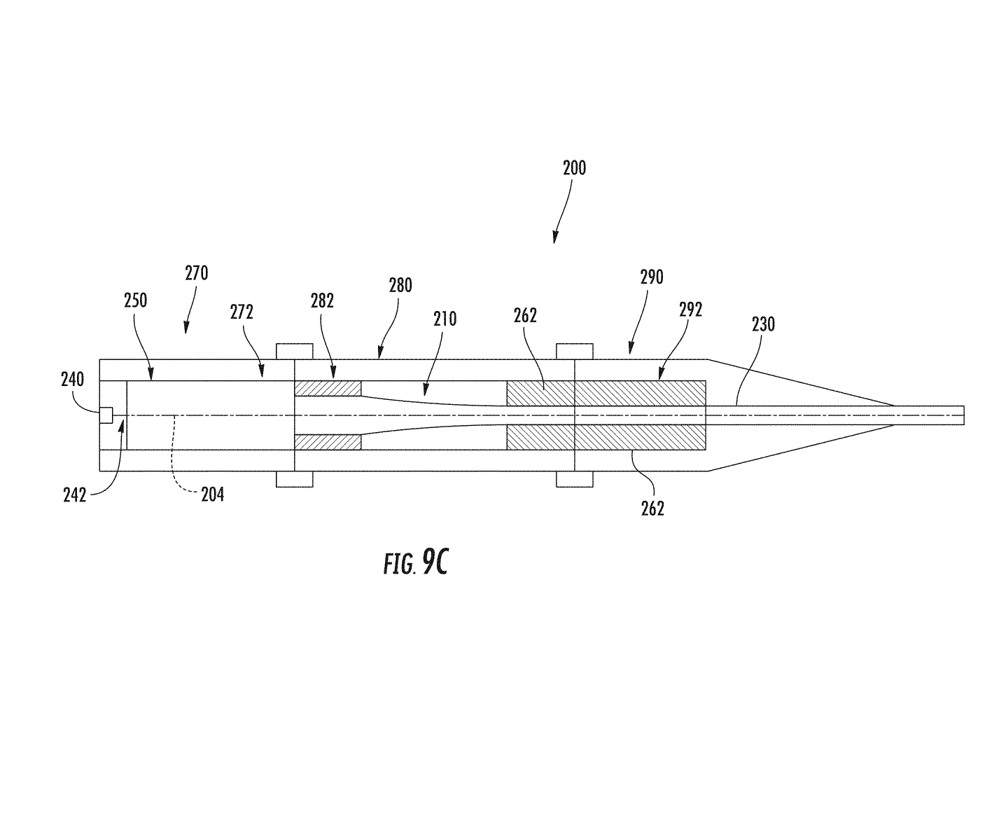

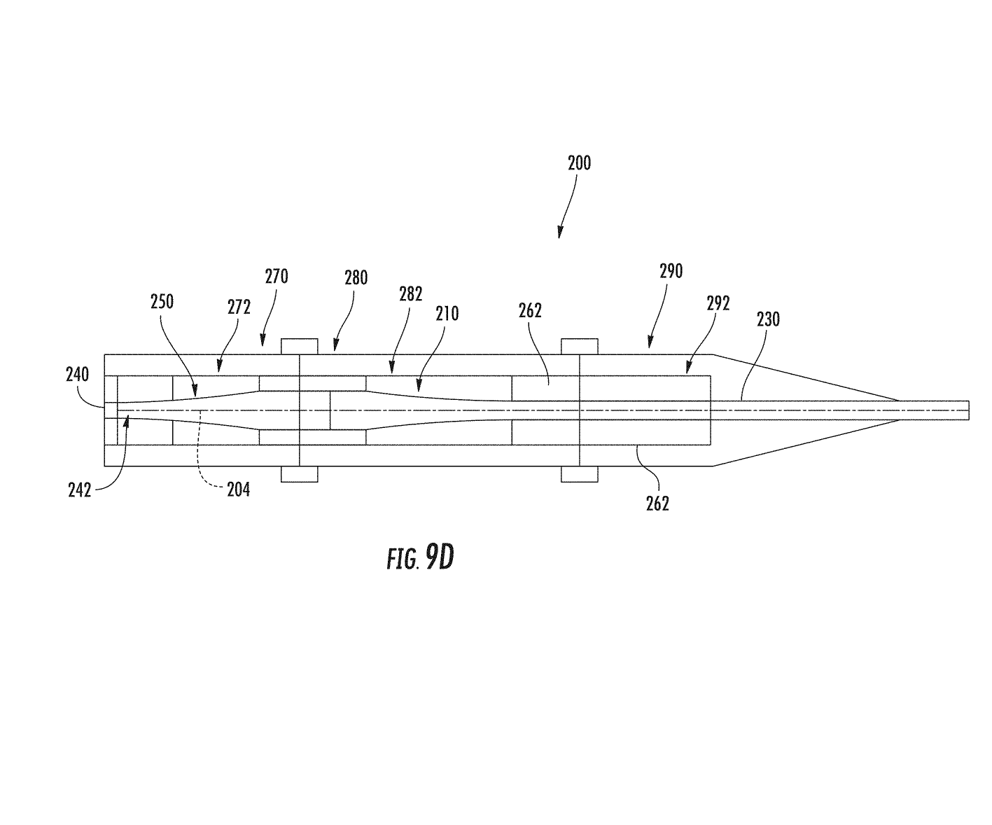

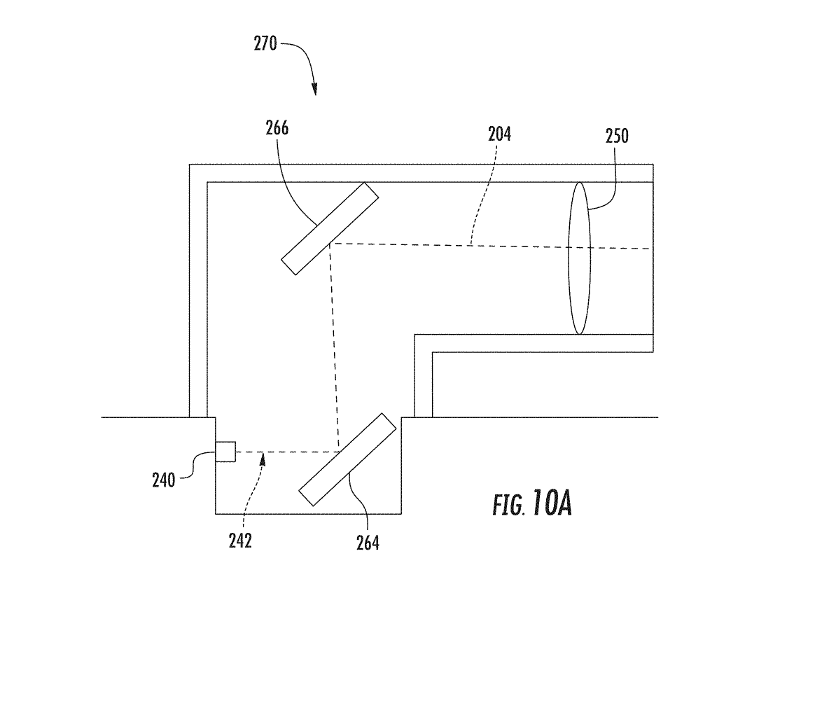

The lens system 150 may additionally or alternatively comprise a spherical lens, an aspheric lens, a cylindrical lens, an anamorphic lens, a gradient index (GRIN) lens, a diffractive lens, a reverse planar tapered waveguide coupling element, or combinations thereof. The reverse planar tapered waveguide coupling element (FIG. 9D) may be the planar tapered waveguide coupling element 110, but positioned in a reverse orientation (e.g., comprising a tapered waveguide 120 positioned in the reverse orientation). The reverse planar tapered waveguide coupling element may comprise any of the materials and sizes of the planar tapered waveguide coupling element 110 described above. Further, the reverse planar tapered waveguide coupling element is configured to expand the light beam 142 as the light beam 142 traverses the reverse planar tapered waveguide coupling element. The lens system 150 may be factory aligned, for example, using passive alignment vision systems. The lens system 150 may also use active alignment, which may increase alignment accuracy.

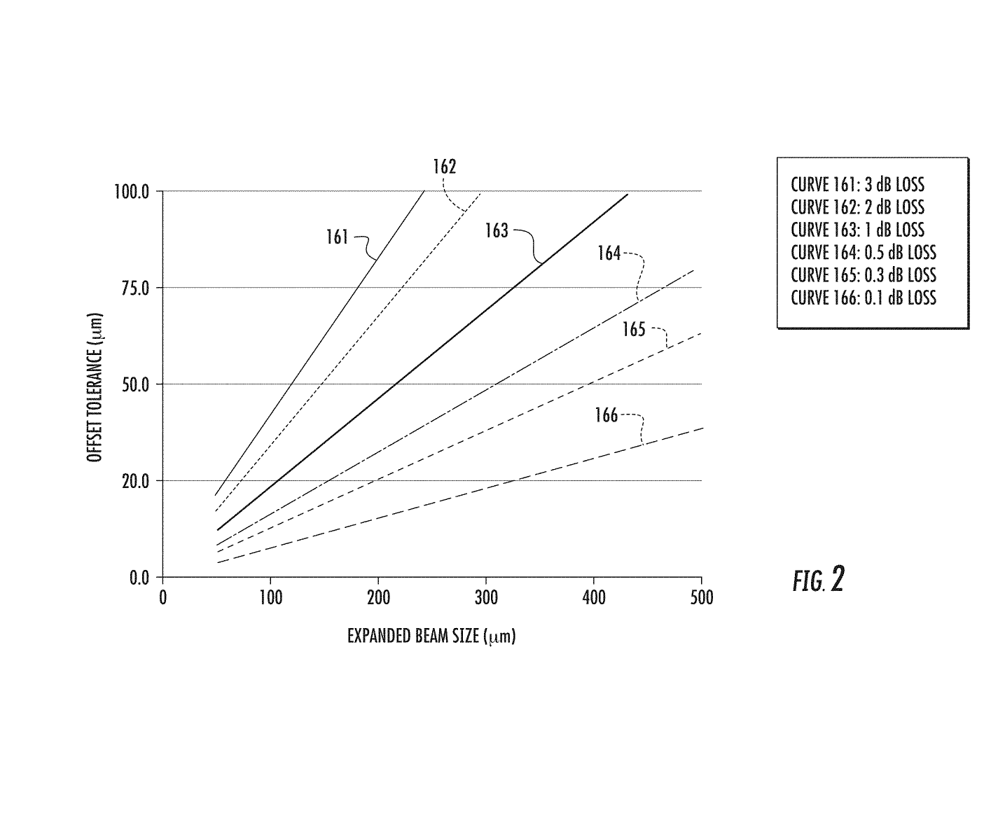

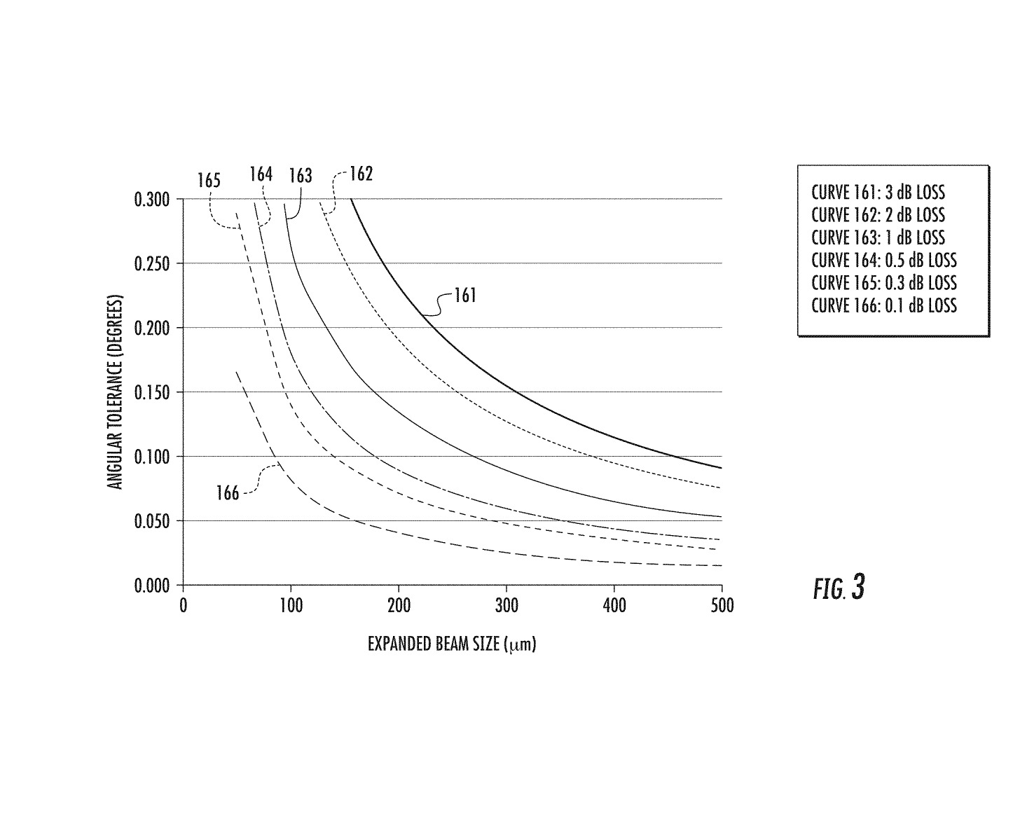

In some embodiments, the lens system 150 may be configured to align and match the light beam 142 with the waveguide diameter 116 of the planar tapered waveguide coupling element 110 to minimize both the angular offset distance and the linear offset distance. The maximum angular and/or linear offset distance for optically coupling the light beam 142 to the planar tapered waveguide coupling element 110 with a desired amount coupling loss is the offset tolerance. While not intending to be limited by theory, offset tolerance is the distance that the light beam 142 can be offset from perfect angular alignment or perfect linear alignment with the planar tapered waveguide coupling element 110 while remaining at or below a desired amount of coupling loss. Minimizing the angular offset distance and the linear offset distance can minimize coupling loss. FIGS. 2 and 3 graphically depict the angular and linear offset tolerance of a 1550 nm wavelength light beam 142 at varying beam sizes while retaining a set amount of coupling loss.

Referring now to FIG. 2, as the mode field diameter of the expanded light beam 142 increases, the linear alignment tolerance increases linearly. In particular, FIG. 2 depicts the amount of linear offset the light beam 142 can have while retaining different levels of coupling loss. For example, a light beam 142 with lower coupling loss, such as the 0.1 decibel (dB) coupling loss depicted by curve 166, has a smaller linear tolerance than a light beam 142 having a higher coupling loss, such as the 3 dB loss depicted by curve 161. FIG. 2 depicts the linear offset tolerance at different expanded beam sizes for six different coupling loss levels. Curve 161 depicts the linear offset tolerance and expanded light beam size relationship for a 3 dB coupling loss. Curve 162 depicts the linear offset tolerance and expanded light beam size relationship for a 2 dB coupling loss. Curve 163 depicts the linear offset tolerance and expanded light beam size relationship for a 1 dB coupling loss. Curve 164 depicts the linear offset tolerance and expanded light beam size relationship for a 0.5 dB coupling loss. Curve 165 depicts the linear offset distance tolerance and expanded light beam size relationship for a 0.3 dB coupling loss. Further, curve 166 depicts the linear offset distance tolerance and expanded light beam size relationship for a 0.1 dB coupling loss.

Referring now to FIG. 3, as the mode field diameter of the expanded light beam 142 increases, the angular alignment tolerance decreases nonlinearly. In particular, FIG. 3 depicts the amount of angular offset the light beam 142 can have while retaining different levels of coupling loss. For example, the light beam 142 having a lower coupling loss, such as the 0.1 dB coupling loss depicted by curve 166, has a smaller angular offset tolerance than the light beam 142 having a higher coupling loss, such as the 3 dB loss depicted by curve 161. Further, for each of these levels of coupling loss, as the mode field diameter of the light beam 142 increases, the angular offset tolerance decreases non-linearly. For example, the drop in angular offset tolerance is greater as the light beam 142 expands from about 100 μm to about 200 μm than the drop in angular offset tolerance from about 200 μm to about 300 μm. FIG. 3 depicts the angular offset tolerance at different expanded beam sizes for six different coupling loss levels. Curve 161 depicts the angular offset tolerance and expanded light beam size relationship for a 3 dB coupling loss. Curve 162 depicts the angular offset tolerance and expanded light beam size relationship for a 2 dB coupling loss. Curve 163 depicts the angular offset tolerance and expanded light beam size relationship for a 1 dB coupling loss. Curve 164 depicts the angular offset tolerance and expanded light beam size relationship for a 0.5 dB coupling loss. Curve 165 depicts the angular offset distance tolerance and expanded light beam size relationship for a 0.3 dB coupling loss. Further, curve 166 depicts the angular offset distance tolerance and expanded light beam size relationship for a 0.1 dB coupling loss.

In some embodiments, an optimal expanded beam mode field diameter may be chosen to produce a desired coupling loss by having both achievable linear and angular alignment tolerances. This may produce low coupling loss when optically coupling the light source 140 with a receiving fiber 130. For example, when optically coupling the light source 140 and a single mode laser beam, an expanded light beam 142 having a mode field diameter between about 20 μm and 200 μm, such as 30 μm, 50 μm, 75 μm, 100 μm, and 150 μm, may be able to produce low levels of coupling loss and may increase the dust/contamination tolerance of the optical coupling 100. In some embodiments, a contamination particle size in a non-controlled room environment ranges from about 2 μm to about 30 μm. The expanded beam size of the light beam 142 may need to be larger than the potential contamination particle size to minimize loss due to particle contamination within the optical pathway 104. When the mode field diameter is larger than 200 μm, the angular alignment tolerance becomes small for current cost-effective mechanical designs for single mode connectors.

Referring again to FIG. 1, the receiving fiber 130 may comprise an optical fiber, such as, for example, a single mode optical fiber, multimode optical fiber, single mode multi-core optical fiber, multimode multi-core optical fiber, or the like. The receiving fiber 130 is optically coupled to the second end 114 of the planar tapered waveguide coupling element 110. In some embodiments, an optical core diameter (OCD) of the receiving fiber 130 is equivalent the waveguide diameter 116 at the second end 114 of the planar tapered waveguide coupling element 110. The second end 114 of the planar tapered waveguide coupling element 110 may be attached to the receiving fiber 130 using index matching adhesive bonding, fusion splicing, mechanical splicing, or the like. In operation, matching the waveguide diameter 116 at the second end 114 of the planar tapered waveguide coupling element 110 with the OCD of the receiving fiber 130 facilitates alignment and attachment, and also optically couples the planar tapered waveguide coupling element 110 and the receiving fiber 130 such that the optical pathway 104 enters the receiving fiber 130 with minimal coupling loss. In particular, the planar tapered waveguide coupling element 110 is configured such that the numerical aperture (NA) and the waveguide diameter 116 at the second end 114 of the planar tapered waveguide coupling element 110 are close to or match the NA and the OCD of the receiving fiber 130.

In operation, the first end 112 of the planar tapered waveguide coupling element 110 can receive a light beam 142 emitted by the light source 140 having a first beam size and taper the light beam 142 to a second beam size at the second end 114 of the planar tapered waveguide coupling element 110. The second beam size may be smaller than the first beam size and, in some embodiments, the second beam size may be substantially equal to the core diameter of the receiving fiber 130. The first end 112 of the planar tapered waveguide coupling element 110 may support more modes than the second end 114 of the planar tapered waveguide coupling element 110. In one embodiment, a majority of the light beam 142 from the light source 140 may be coupled to one or more desired modes at the first end 112 (i.e. the larger end) of the planar tapered waveguide coupling element 110 to minimize insertion loss through the planar tapered waveguide coupling element 110. The desired modes at the first end 112 are the number of lower order modes that are equal to or less than the number of modes supported by the second end 114. In some embodiments, if a higher order mode outside the desired modes is excited, the light positioned in that higher order mode is lost through the planar tapered waveguide coupling element 110 as it is not supported by the second end 114. Accordingly, coupling the light beam 142 from the light source 140 to the desired modes reduces the insertion loss through the planar tapered waveguide coupling element 110. The planar tapered waveguide coupling element 110 has a tapered waveguide diameter 116 that may adiabatically transition the light beam 142 traversing the planar tapered waveguide coupling element 110. In particular, the tapered shape of the waveguide diameter 116 may transition the light beam 142 from the first beam size to the second beam size while the light beam 142 remains at one of the one or more of the desired modes. Adiabatic transition provides light beam 142 transition having low propagation loss and no mode coupling to undesired higher order modes. For example, the light beam 142 at the first end 112 and at the second end 114 of the planar tapered waveguide coupling element 110 may be one of the one or more desired modes.

While not intending to be limited by theory, the waveguide diameter 116 adiabatically transitions the light beam 142 along the optical pathway 104 such that a propagation loss within the tapered coupling element may be, for example, less than about 1 dB, less than about 0.5 dB, or less than about 0.1 dB. To achieve adiabatic transition, the slope of the diameter of the tapered waveguide 120 (i.e. the taper shape) may satisfy the condition of Equation 1, below. In some embodiments, the slope of the waveguide diameter 116 should not be too steep.

$$\frac{dD}{dz} \leq \frac{D}{λ} ( {n}_{m} - {n}_{{m}^{′}} ) \qquad ( 1 )$$

In Equation 1, D is the waveguide diameter 116 (average waveguide diameter 116 in tapered waveguides 120 comprising non-circular cross sections), λ is the wavelength of the light beam 142, nₘ is the effective index of an m mode group, n_{m′} is the effective index of an m′ mode group, and z is distance along the length of the planar tapered waveguide coupling element 110. The m mode group and the m′ mode group are adjacent mode groups of the light beam 142 having a wavelength of λ in the tapered waveguide 120, i.e. m′=m+1. The m mode group and the m′ mode group can be any adjacent mode groups within the tapered waveguide 120 for the light beam 142. In particular, the m mode group and the m′ mode group are the two adjacent mode groups of the light beam 142 having the most similar effective indexes at a point along the length of the planar tapered waveguide coupling element 110. While not intended to be limited by theory, the two mode groups m and m′ are two mode groups within the light beam 142 having refractive indexes that make the value (nₘ-n_{m′}) smallest. Further, it should be understood that, with respect to these adjacent mode groups, nₘ has a larger effective index than n_{m′}, such that the value is a positive value. In some embodiments, the mode group number m is equivalent to the number of mode groups supported by the second end 114 of the planar tapered waveguide coupling element 110. Accordingly, the slope of the waveguide diameter 116 may be calculated from the Equation 1. Further, Equation 1 may be used to determine both the taper shape and the taper length given the waveguide diameter 116 at the first end 112 and the second end 114 of the planar tapered waveguide coupling element 110.

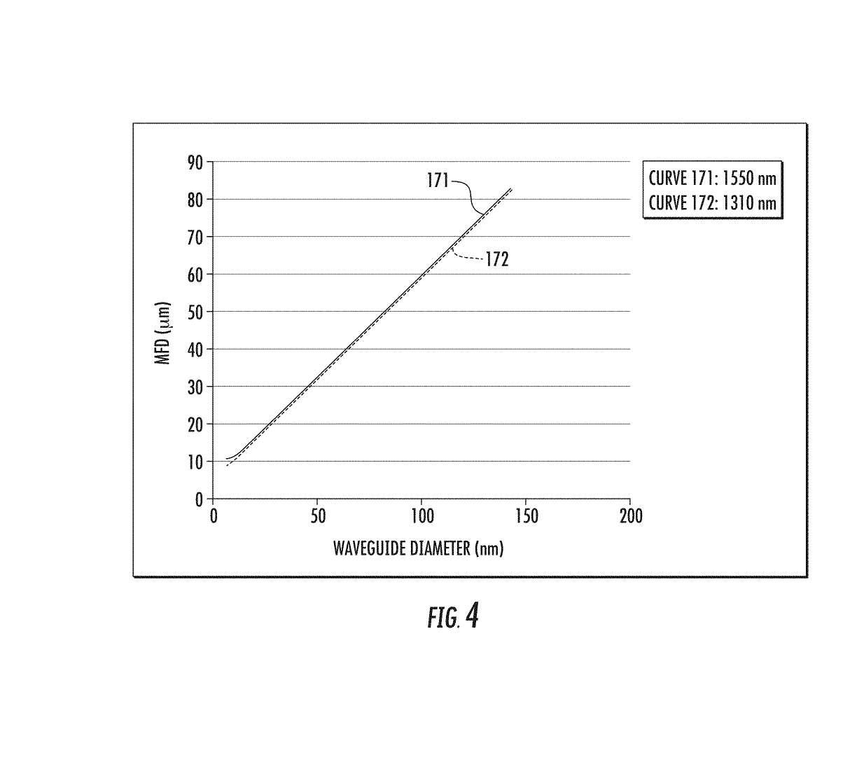

Referring now to FIG. 4, mode field diameter (MFD) as a function of waveguide diameter for the fundamental mode of an example light beam 142 is graphically depicted. In FIG. 4, curve 171 represents a light beam 142 with a wavelength of 1550 nm and curve 172 represents a light beam 142 having a wavelength of 1310 nm. In this non-limiting example, the planar tapered waveguide coupling element 110 is designed to optically couple a light source 140 and a single mode receiving fiber 130. This exemplary planar tapered waveguide coupling element 110 has a step index profile design similar to standard single mode fiber that includes a core relative refractive index or delta of 0.34%. In this example, the waveguide diameter 116 at the first end 112 is about 82 μm and the waveguide diameter 116 at the second end 114 is about 8.8 μm to optically couple a collimated light beam 142 having a 50 μm MFD into a single mode receiving fiber 130 having a core diameter of about 8.8 μm with minimal coupling loss.

In operation, as the waveguide diameter 116 decreases, the MFD of the light beam 142 decreases. When the light beam 142 reaches the second end 114, (having a waveguide diameter of about 8.8 μm), the MFD of a 1310 nm light beam 142 and 1550 nm light beam 142 are 9.3 μm and 10.4 μm, respectively. Further, in this example, the length of the planar tapered waveguide coupling element 110 should be greater than about 8 mm to facilitate an adiabatic transition, for example 10 mm, 12 mm, 15 mm, or the like.

In another example, the planar tapered waveguide coupling element 110 may be configured to optically couple a light source 140 and a multi-mode receiving fiber 130 such that the light beam 142 undergoes adiabatic transition through the planar tapered waveguide coupling element 110. In this example, the receiving fiber 130 comprises a graded index multi-mode fiber having a core delta of 0.75%, an alpha of about 2, and core diameter of about 30 μm. The planar tapered waveguide coupling element 110 comprises a delta of 0.75% and an alpha of about 2. In this example, the first end 112 of the tapered coupling element may have a waveguide diameter 116 of 150 μm. The second end 114 of the planar tapered waveguide coupling element 110 may have a waveguide diameter 116 of 30 μm. Further, the length of the planar tapered waveguide coupling element 110 should be greater than about 3.8 mm to facilitate adiabatic transition, for example, 4 mm, 6 mm, 8 mm, or the like. It should be understood that planar tapered waveguide coupling element 110 may comprise a variety of waveguide refractive index profiles, core deltas and waveguide sizes to couple a variety of light sources 140 and receiving fibers 130. The waveguide refractive index profile can be a step index profile, a graded index profile or multi-segmented index profile. The delta can be between 0.2 to 3%, and may be between 0.3 to 2%, and even may be between 0.3 to 1%. In particular, the size relationships of the planar tapered waveguide coupling element 110 should meet the conditions of Equation 1, above.

In an alternative embodiment, the optical coupling 100 may be configured to optically couple a light source 140 comprising an array of laser/VCSEL sources and a receiving fiber 130 comprising a multi-core optical fiber. In this embodiment, the lens system 150 is telecentric and the planar tapered waveguide coupling element 110 comprises multiple tapered waveguides 120. In a different embodiment, the lens system 150 could be a reversed tapered coupling element having multiple tapered waveguides. In this embodiment, each waveguide diameter of the multiple tapered waveguides 120 may meet the limitations of Equation 1 to facilitate adiabatic transition of a light beam 142 produced by the array of laser/VCSEL sources.

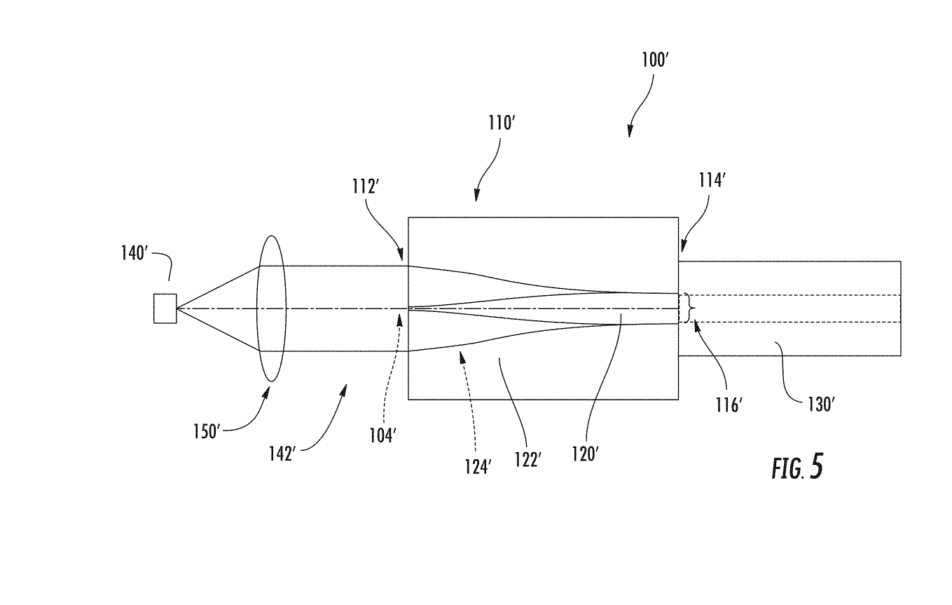

Referring now to FIG. 5, in another alternative embodiment, an optical coupling 100′ may comprise a planar tapered waveguide coupling element 110′ having a tapered waveguide 120′ positioned within a planar substrate 122′. The tapered waveguide 120′ has a waveguide diameter 116′ that is tapered from a smaller first end 112′ to a larger second end 114′. The waveguide diameter 116′ of the tapered waveguide 120′ may have a taper shape configured to support single mode propagation of a light beam 142′ between a light source 140′ and a receiving fiber 130′. For example, the waveguide taper 120′ may be single moded (e.g., configured to guide a single mode, for example, the fundamental mode of the tapered waveguide 120′). In the embodiment depicted in FIG. 5, the tapered waveguide 120′ may be used to couple the light beam 142′ to an example receiving fiber 130′ comprising a single mode optical fiber. The MFD at the second, larger end 114′ may match the MFD of receiving fiber 130′ comprising a single mode optical fiber and the MFD at the first, smaller end 112′ may match the MFD of the expanded light beam 142′. Further, FIG. 5 schematically depicts the MFD change 124′ as the light beam 142′ travels through the planar tapered waveguide coupling element 110.

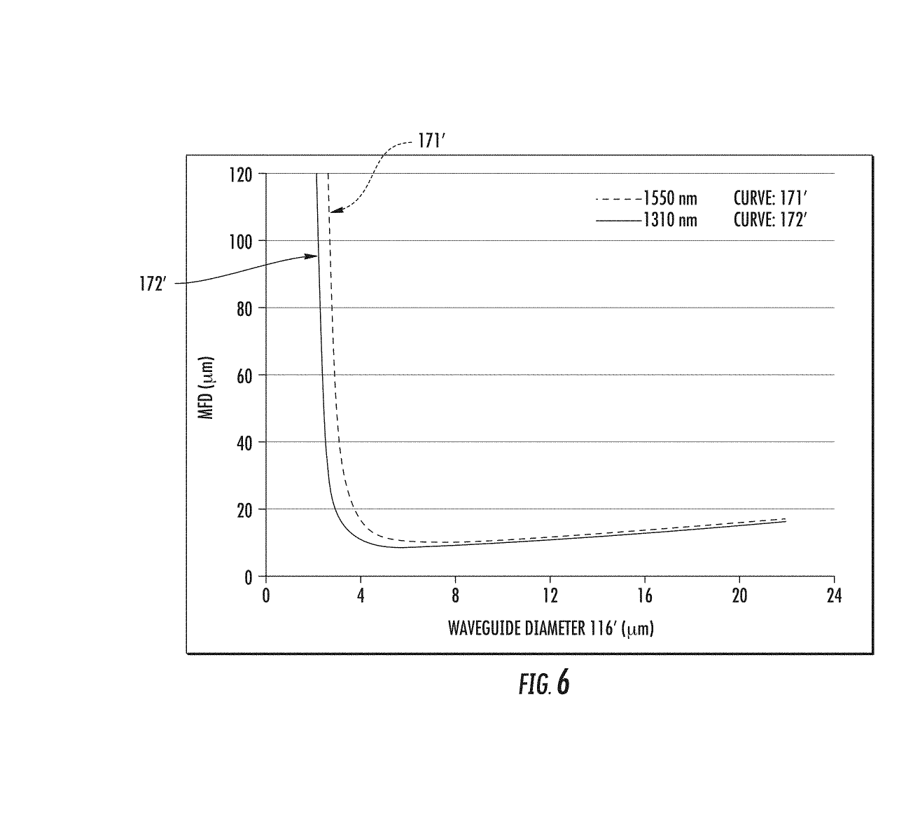

Referring now to FIG. 6, MFD as a function of waveguide diameter 116 for the tapered waveguide 120′ configured to support single mode propagation of a light beam 142′ is graphically depicted. In FIG. 6, curve 171′ represents a light beam 142′ with a wavelength of 1550 nm and curve 172′ represents a light beam 142′ having a wavelength of 1310 nm. In this non-limiting example, the delta of the tapered waveguide 120′ is about 0.34%, similar to the core delta of the standard single mode fiber. Further, as the MFD of the light beam 142′ increases with respect to the tapered waveguide 120′ (e.g., in various embodiments comprising a tapered waveguide 120′ having an increasingly smaller first end 112′), the alignment tolerance for the single mode of the light beam 142′ and the tapered waveguide 120′ increases. This increased alignment tolerance may facilitate easier alignment and installation, for example, field installation.

As depicted in FIG. 6, when the tapered waveguide 120′ comprises a waveguide diameter 116′ of about 8.4 μm, the MFD of light beam 142′ at 1310 nm is about 9.2 μm (represented by curve 171′) and the MFD of light beam 142′ at 1550 nm is about 10.4 μm (represented by curve 172′), which is similar to the MFDs of single mode optical fiber. Further, when the tapered waveguide 120′ comprises a waveguide diameter 116′ of about 2.6 μm, the MFD of light beam 142′ at 1310 nm, as represented by curve 171′, is increased to about 36 μm and the MFD of light beam 142′ at 1550 nm is increased to about 124 μm (represented by curve 172′). Additionally, when the tapered waveguide 120′ comprises a waveguide diameter 116′ of about 2.2 μm, the MFD of light beam 142′ at 1310 nm is increased to about 102 μm (represented by curve 171′) and the MFD of light beam 142′ at 1550 nm is increased to about 633 μm (represented by curve 172′).

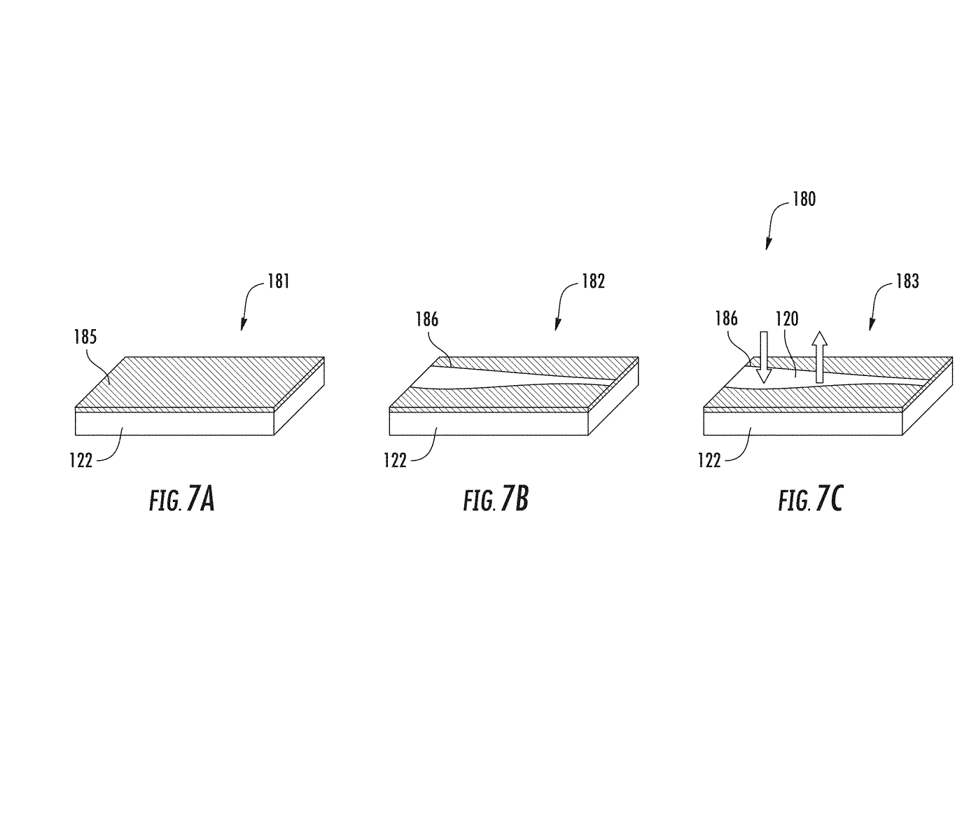

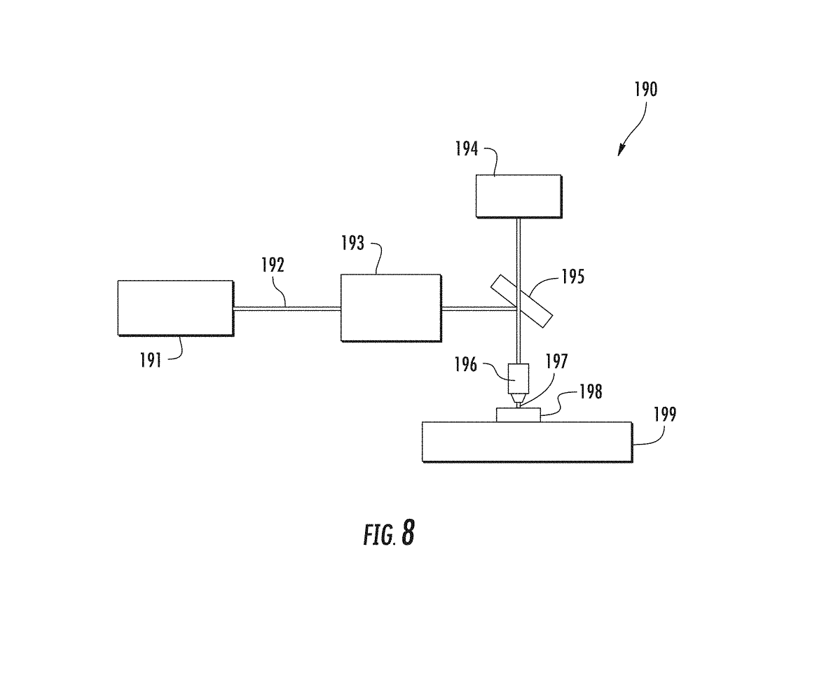

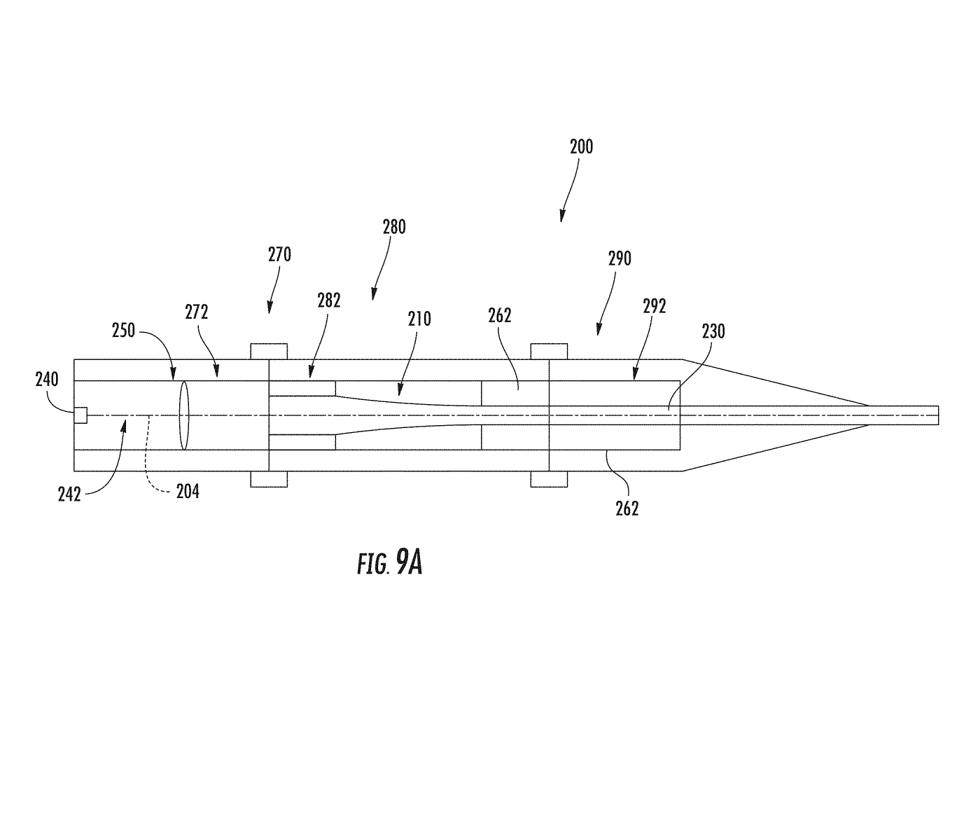

Referring now to FIGS. 7A-7C, in some embodiments, the planar tapered waveguide coupling element 110 may be fabricated using an ion-exchange process 180. The ion-exchange process 180 of fabricating the planar tapered waveguide coupling element 110 comprises three steps (numbered 181, 182, and 183). First, at step 181, as depicted in FIG. 7A, a metal film 185, such as Al, or the like, may be deposited (e.g., masked) onto the planar substrate 122. Next, at step 182, as depicted in FIG. 7B, a taper pattern 186 may be formed on the metal film 185 using a photolithography process, or the like. The taper pattern 186 may comprise the outline and/or the shape of the tapered waveguide 120, for example, the taper pattern 186 may include a waveguide diameter 116 that tapers from the first end 112 to the second end 114. Next, at step 183, as depicted in FIG. 7C, the planar substrate 122 having the metal film 185 and the taper pattern 186 may be placed in a molten salt bath, for example, a KNO₃ bath, a AgNO₃ bath, or the like. Ion-exchange occurs within the molten salt bath, for example, ion-exchange between K⁺ in the molten salt and Na⁺ in the planar substrate 122 and ion exchange between Ag+ in the molten salt and Na+ in the planar substrate 122. This ion-exchange generates a tapered waveguide 120 within the planar substrate 122. While the ion-exchange process 180 is described above with respect to steps 181, 182, and 183, it should be understood that the planar tapered waveguide coupling element 110 may be fabricated using any exemplary ion-exchange process.

Referring to FIG. 8, in some embodiments, the planar tapered waveguide coupling element 110 and 110′ may be fabricated using a laser inscription process, for example, using a laser writing system 190. The laser inscription method includes directing a laser pulse beam 192 generated by a laser 191, for example a femtosecond (“fs”) laser, at a glass sample 198 (e.g., the planar substrate 122 and 122′ described above) through a microscope objective 196. In some embodiments, the laser pulse beam 192 may comprise a fs laser pulse beam having a wavelength between about 700 to 1600 nm, for example 800 nm, 1030 nm, 1060 nm, 1550 nm, pulse rate between about 100 to 1000 kHz, and a pulse energy of between about 1000 and 5000 nJ. In some embodiments, the laser pulse beam 192 may have a laser pulse width less than about 500 ps, for example 500, 400, 300, 200, 100, 50, 30 fs. In some embodiments, a beam shaping system 193 may be used to produce desired beam shape for laser inscription. Additionally, the laser writing system 190 may include a dichroic mirror 195 configured to turn the laser pulse beam 192.

Referring still to FIG. 8, the laser inscription process may generate an index change within the glass sample 198 at a contact location 197 between a focal point of the laser pulse beam 192 and a portion of the glass sample 198 through a two-photon absorption process. During the laser inscription process, the glass sample 198 may be mounted on a motion stage 199 to change the contact location between a focal point of the laser pulse beam 192 and a portion of the glass sample 198. In some embodiments, the motion stage 199 may comprise a one-axis motion stage, a two-axis motion stage, a three-axis motion stage, or the like. The motion stage 199 of the laser writing system 190 may be controlled by a computing device to maneuver the glass sample 198 with respect to the laser pulse beam 192 and generate the desired patterns within the glass sample 198, for example, to generate the planar tapered waveguide coupling element 110 described herein. In some embodiments, the laser inscription velocity along the glass sample 198 may be between about 10 mm/s and about 50 mm/s. Further, in some embodiments, the laser writing system 190 may comprise a camera 194 (e.g., a charge-coupled device (CCD)) to monitor the laser inscription process. For example, the camera 194 may be used to obtain a live view and/or capture images of the laser inscription process.

In one non-limiting example, a planar tapered waveguide coupling element 110 fabricated using the laser inscription process comprises a first end 112 having a waveguide diameter of about 26 μm and a second, smaller end 114 having a waveguide diameter of about 9 μm. This example planar tapered waveguide coupling element 110 may be fabricated using an exemplary laser pulse beam 192 comprising a short pulse laser having a wavelength of about 800 nm, a pulse width of about 300 fs, and pulse energy of about 4 uJ. This planar tapered waveguide coupling element 110 may have a coupling efficiency of about 3 dB when butt coupled to a single mode optical fiber. It should be understood that the ion-exchange process 180 and the laser writing system 190 may be used to fabricate any of the planar tapered waveguide coupling elements 110, 110′, 210, 310, 410, and 510 described herein.

In additional embodiments depicted in FIGS. 9A-9D, example optical coupling 200 for a photonics circuit, including a light source connector 270, a tapered coupling element connector 280 and a receiving fiber connector 290 are depicted. In the embodiments depicted in FIGS. 9A-9D, the light source connector 270 includes a light source housing 272 for housing a light source 240, the tapered coupling element connector 280 includes a tapered coupling element housing 282 for housing the planar tapered waveguide coupling element 210, and the receiving fiber connector 290 includes a receiving fiber housing 292 for housing the receiving fiber 230. In some embodiments, the light source connector 270, the tapered coupling element connector 280 and the receiving fiber connector 290 are integral. In other embodiments they are coupled together using a connector interface, for example, any exemplary metal or plastic connecting device. Further, each end of the tapered coupling element connector 280 may be polished.

In the embodiments depicted in FIGS. 9A-9D, the planar tapered waveguide coupling element 210 may comprise an embodiment of the planar tapered waveguide coupling element 110 and/or 110′ described above, and may be secured within the tapered coupling element housing 282 using one or more ferrules 262. The ferrules 262 may comprise ceramic material, plastic material, metal material, or the like. The ferrules 262 may consist of two or more ferrule segments, or an individual ferrule that matches the shape of the planar tapered waveguide coupling element 210. The receiving fiber 230 may comprise the various receiving fibers 130 described above and may be secured within the receiving fiber housing 292 using one or more ferrules 262. Further, the light source 240 may comprise the various light sources 140 described above.

The illustrated optical coupling 200 further comprise a lens system 250, such as the lens system 150 described above and illustrated in FIG. 1. The lens system 250 may be housed within the light source housing 272 or the tapered coupling element housing 282 and positioned within an optical pathway 204 between the light source 240 and the planar tapered waveguide coupling element 210. In FIG. 9A, the lens system 250 comprises a collimating lens positioned within the light source connector 270. In FIG. 9B, the lens system 250 comprises a collimating lens positioned within the tapered coupling element connector 280. In FIG. 9C, the lens system 250 comprises a GRIN lens, configured to expand the light beam 242 and positioned within the light source connector 270. In FIG. 9D, the lens system 250 comprises a reverse tapered coupling element configured to expand the beam and secured within the light source housing 272 using one or more ferrules 262.

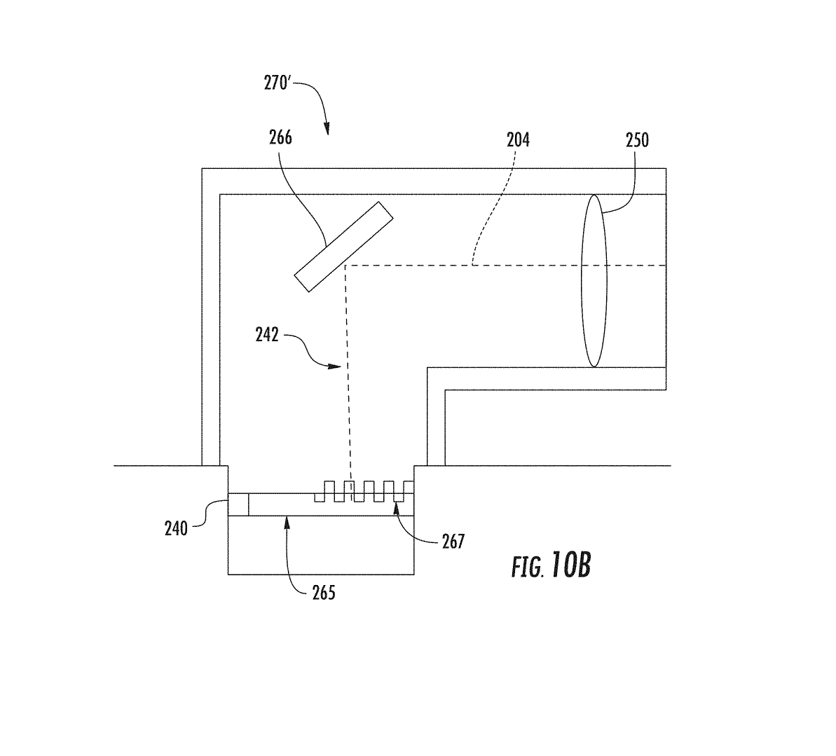

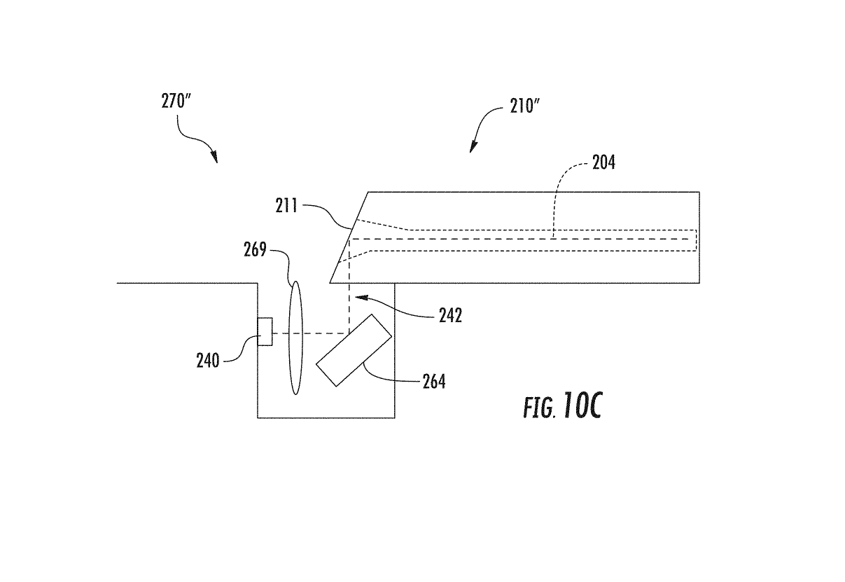

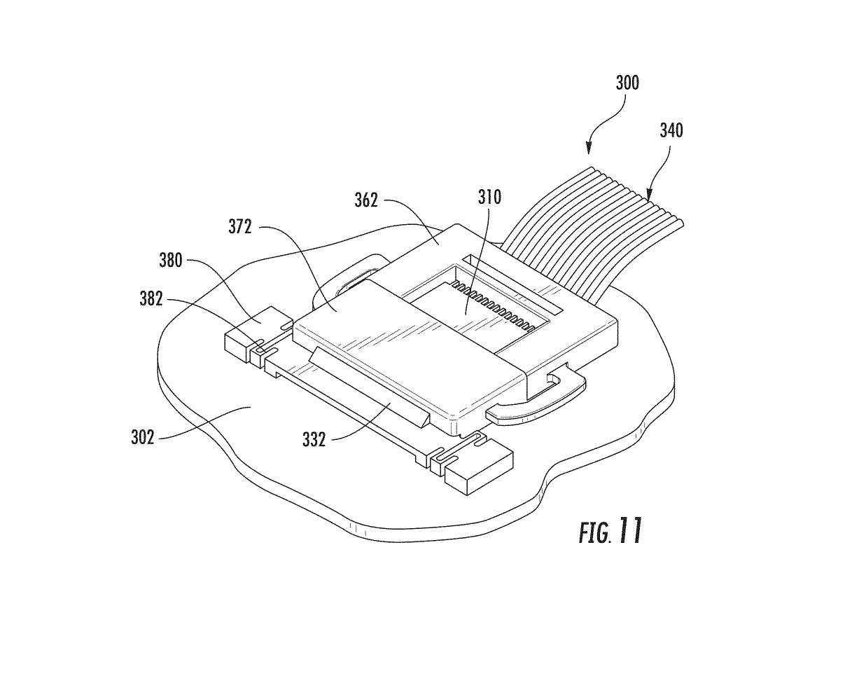

Referring now to FIG. 10A, an alternative embodiment of the light source connector 270 is schematically depicted. In this embodiment, the light source connector 270 comprises two reflective mirrors 264, 266 configured to direct the light beam 242 into the lens system 250, for example, when the light source 240 and the lens system 250 are not directly aligned. Further, the light source connector 270 may be mounted to a laser module board, printed circuit board, or the like. In some embodiments, the two reflective mirrors 264, 266 and lens system 250 may be a single molded part, and the light is reflected using total internal reflection. Referring to FIG. 10B, an another alternative embodiment of a light source connector 270′ is schematically depicted. the reflective mirror 264 may be replaced by a waveguide 265 having gratings 267 positioned such that the waveguide 265 is optically coupled to the light source 240 to direct the light beam 242 toward the reflective mirror 266. Referring to FIG. 10C, another alternative embodiment of a light source connector 270″ is schematically depicted. In this embodiment, the reflective mirror 266 shown in FIG. 10A is replaced by an angled, polished end-face 211 of a tapered waveguide element 210″. In this embodiment, the light beam 242 from the light source 240 is directed by the lens 269 and the mirror 264 to the angled end-face 211 redirect the light beam 242 into the tapered waveguide element 210″ to thereby couple the light beam 242 into the tapered waveguide element 210″. As an example and not a limitation, the angle of the angled end-face 211 of the tapered waveguide element 210″ may be 45°. It is noted that, in alternative embodiments, the angled end-face can also be placed on top of the waveguide 265 as shown in FIG. 10B.

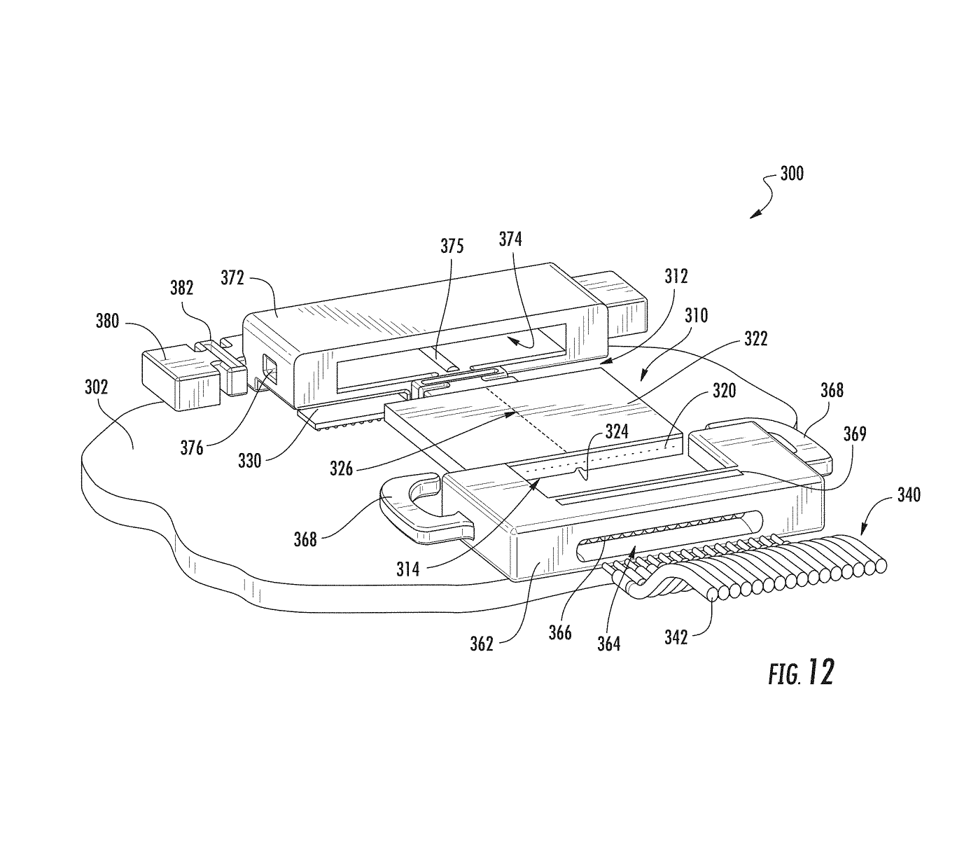

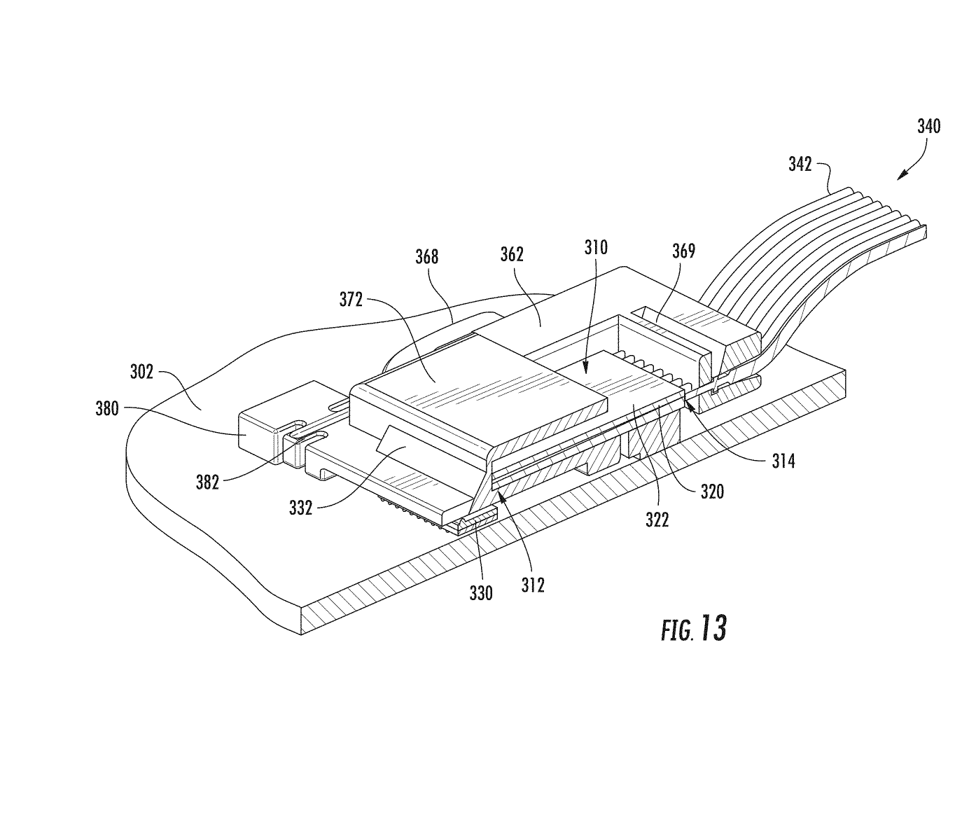

Referring now to FIGS. 11 and 12, a molded optical coupling 300 for a photonics circuit comprising a planar tapered waveguide coupling element 310 is depicted. It is noted that FIG. 12 is an exploded view of the molded optical coupling 300 depicted in FIG. 11. The planar tapered waveguide coupling element 310 of the illustrated embodiment is positioned within a connector body 362 and/or a receptacle body 372 and optically couples an array of optical fibers 340 with a photonic integrated circuit (IC) 330. The planar tapered waveguide coupling element 310 may include an array of tapered waveguides 320, each configured to optically couple an individual optical fiber 342 of the array of optical fibers 340 with the photonics IC 330. In some embodiments, the molded optical coupling 300 may be a fiber-to-silicon coupling element and may be used in silicon photonics. In this embodiment, the photonics IC 330 may comprise a silicon photonic IC, or the like. Further, the molded optical coupling 300 may include a printed circuit board (PCB) 302. The connector body 362 the receptacle body 372, and the photonics IC 330 may each be attached to the PCB 302. Further, in some embodiments, the photonics IC 330 may be communicatively coupled and/or optically coupled to the PCB 302.

Referring still to both FIGS. 11 and 12, the planar tapered waveguide coupling element 310 may be configured as any of the planar tapered waveguide coupling elements 110, 110′, and 210 described above. The planar tapered waveguide coupling element 310 may comprise an array of tapered waveguides 320 positioned within a planar substrate 322. The array of tapered waveguides 320 may comprise a first end 312 and a second end 314. The waveguide diameter of each individual tapered waveguide of the array of tapered waveguides 320 may be larger at the first end 312, smaller at the second end 314, and may comprise any of the tapered shapes described above with respect to the planar tapered waveguide coupling elements 110, 110′, and 210. In some embodiments, the planar tapered waveguide coupling element 310 may be about 8-10 mm in length between the first end 312 and the second end 314. In some embodiments, the array of tapered waveguides 320 may comprise uniform taper shapes. In other embodiments, the array of tapered waveguides 320 may be non-uniform such that at least two tapered waveguides have differing taper shapes. Further, an alignment slot 324 may be positioned along a surface of the planar tapered waveguide coupling element 310. For example, the alignment slot 324 may comprise an elongated indent extending into the surface of the planar tapered waveguide coupling element 310 from the first end 312 to the second end 314. The alignment slot 324 may be positioned substantially along a centerline 326 of the planar tapered waveguide coupling element 310. It should be understood that more than one alignment slot may be provided. Further, the material of the planar tapered waveguide coupling element 310 may comprise substantially the same thermal properties as silicon.

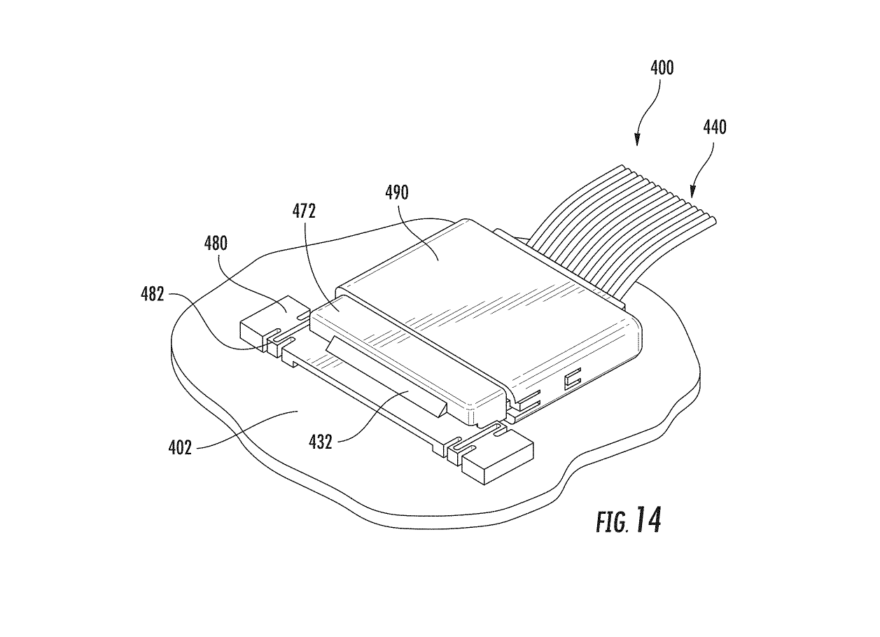

Referring to FIG. 13, a sectional view of the molded optical coupling 300 depicted in FIGS. 11 and 12 is depicted. In some embodiments, the connector body 362 cooperates with the receptacle body 372 to house the planar tapered waveguide coupling element 310 and optically couple the array of optical fibers 340 with the photonics IC 330. For example, the first end 312 of the planar tapered waveguide coupling element 310 may be positioned within the receptacle body 372 and the second end 314 may be positioned within the connector body 362, for example, bonded to the connector body 362. In this embodiment, the first end 312 is optically coupled to the photonics IC 330 and the second end 314 is optically coupled to the array of optical fibers 340. It should be understood that the other arrangements are contemplated, for example, the second end 314 may be positioned within the receptacle body 372 and the first end 312 may be positioned within the connector body 362.

As depicted in FIGS. 11-13, the connector body 362 of the illustrated embodiments comprises a fiber receiving opening 364 sized and positioned such that the array of optical fibers 340 may extend through the fiber receiving opening 364 and be optically coupled (i.e. mate with) the planar tapered waveguide coupling element 310. For example, the array of optical fibers 340 may be precision cleaved and abutted to the array of tapered waveguides 320 at the second end 314 of the planar tapered waveguide coupling element 310. Further, the fiber receiving opening 364 may comprise a plurality of fiber coupling slots 366 each configured to hold an individual optical fiber 342 in optical engagement with an individual tapered waveguide of the array of tapered waveguides 320. Further, in some embodiments, the connector body 362 may comprise a well 369 opening into the fiber receiving opening 364. The well 369 may be sized and positioned such that the well 369 may receive a suitable adhesive (e.g., an optical adhesive) for securing the one or more optical fibers 340 to the connector body 362. It should be understood that the array of optical fibers 340 may comprise any exemplary optical fibers, such as, for example, single mode optical fiber, multimode optical fiber, single mode multi-core optical fiber, multimode multi-core optical fiber, or the like.

The receptacle body 372 of the illustrated embodiment comprises a substrate opening 374 configured to house a portion of the planar tapered waveguide coupling element 310, for example, the first end 312 as described above. The substrate opening 374 may comprise a centering rib 375 (FIG. 12) positioned within the substrate opening 374, for example, centrally located within the substrate opening 374. The centering rib 375 engages the alignment slot 324 of the planar tapered waveguide coupling element 310. The engagement between the centering rib 375 and the alignment slot 324 provides an aligned engagement between the planar tapered waveguide coupling element 310 and the receptacle body 372 such that the array of tapered waveguides 320 may be optically coupled with and optically aligned with the array of lens of the photonics IC 330.

Referring still to FIGS. 11-13, the receptacle body 372 may be removably coupled to the connector body 362. To facilitate this removable engagement, the connector body 362 may comprise one or more receptacle arms 368 configured to engage with corresponding arm receiving slots 376 of the receptacle body 372. Further, the receptacle arms 368 may be inwardly biased such that receptacle arms 368 may extend into the arm receiving slots 376 and hold the connector body 362 in engagement with the receptacle body 372. In some embodiments, the connector body 362 comprises one receptacle arm 368 and, in other embodiments, for example, as depicted in FIGS. 11-13, the connector body 362 comprises two receptacle arms 368, each extending outward from a side of the connector body 362, for example, opposite sides of the connector body 362. It should be understood that any number of receptacle arms 368 are contemplated. It should also be understood that other means for providing removable engagement between the connector body 362 and the receptacle body 372 may be employed.

The receptacle body 372 of the illustrated embodiment comprises a total internal reflection (TIR) structure 332 positioned such that the first end 312 of the planar tapered waveguide coupling element 310 is optically aligned with the TIR structure 332 when the planar tapered waveguide coupling element 310 is positioned within the substrate opening 374. In some embodiments, the TIR structure 332 may be the light source connector 270 described above with respect to FIG. 10. Further, the TIR structure 332 may comprise a molded TIR structure, for example a plastic such as polyimide (e.g., an EXTEM™ thermoplastic polyimide), or the like. In some embodiments, the TIR structure 332 may be coupled to the receptacle body 372 and, in other embodiments, the TIR structure 332 may be integral with the receptacle body 372.

As depicted in FIGS. 11-13, the photonics IC 330 of the molded optical coupling 300 may be communicatively coupled to the PCB 302 and optically coupled to the planar tapered waveguide coupling element 310 such that light emitted by the photonics IC 330 may be received by the array of optical fibers 340 and vice versa. Further, the photonics IC 330 may be optically coupled to the TIR structure 332 (for example, directly coupled to the photonics IC 330 and positioned above photonics IC 330) such that the TIR structure 332 optically couples the planar tapered waveguide coupling element 310 and the photonics IC 330. For example, the TIR structure 332 may be configured to turn the optical pathway to facilitate optical coupling when the lens array of the photonics IC 330 is not in direct alignment with the planar tapered waveguide coupling element 310, for example, when the photonics IC 330 is positioned substantially orthogonal the planar tapered waveguide coupling element 310.

The receptacle body 372 and/or the connector body 362 may be coupled to the PCB 302, which may comprise an FR-4, AOC, or any exemplary embedded solution. In some embodiments, the receptacle body 372 and/or the connector body 362 may be coupled to the PCB 302 using one or more bond pads 380 positioned between the connector body 362 and/or the receptacle body 372 and the PCB 302. In some embodiments, the bond pads 380 are integral with or coupled to the connector body 362 and/or the receptacle body 372, for example, adhesive bonded, UV bonded, or the like. The bond pads 380 may comprise flexures 382 configured to expand and/or contract when an expanding or contracting force is applied to one or more of the components of the molded optical coupling 300, for example, the PCB 302, the receptacle body 372, the connector body 362, the bond pads 380, or the like.

This expanding or retracting force may result from temperature change. For example, the flexures 382 may absorb length and width increases as the molded optical coupling 300 temperature rises from ambient to operating temperatures. Further, by providing symmetric flexures 382, the expansion or contraction of the molded optical coupling 300 may be substantially uniform such that the receptacle body 372 and/or the connector body 362 expands and contracts substantially about the centering rib 375. By aligning the planar tapered waveguide coupling element 310 in the receptacle body 372 with centering rib 375, the optical coupling between the array of optical fibers 340 and the array of lens of the photonics IC 330 may remain aligned, even during expansion and retraction of the molded optical coupling 300.

The molded optical coupling 300 having a planar tapered waveguide coupling element 310 may be assembled by first fabricating the planar substrate 322 comprising the alignment slot 324 and positioning the planar substrate 322 within the connector body 362 (e.g., by bonding using index matching optical path adhesive, UV bonding, or the like). The array of optical fibers 340 may then be cleaved and abutted to the second end 314 of the planar substrate 322. Next, the array of tapered waveguides 320 may be laser printed into the planar substrate 322 using any exemplary laser printing methods, for example, using the laser inscription process described above with respect to FIG. 8. Each tapered waveguide may be laser printed by aligning the second end 314 of each tapered waveguide with each individual optical fiber 342 (e.g., using vision alignment), directing the laser pulse beam (e.g., the laser pulse beam 192) at the planar substrate 322 to generate an index change within the planar substrate 322, providing relative motion between the laser pulse beam and the planar substrate 322 such that the laser pulse beam moves between the second end 314 and the first end 312 to form at least one tapered waveguide. Further, the first end 312 of each tapered waveguide may be aligned with respect to the alignment slot 324. The alignment slot 324 provides a positioning landmark such that the array of tapered waveguides 320 may be fabricated in situ while the planar substrate 322 is positioned within the connector body 362. Alternatively, the array of tapered waveguides 320 may be laser printed into the planar substrate 322 (using any of the above described laser printing methods) before the planar tapered waveguide coupling element 310 is assembled into the molded optical coupling 300. In this embodiment, the molded optical coupling 300 is assembled by laser printing the array of tapered waveguides 320 into the planar substrate 322, aligning the second end 314 of each tapered waveguide with each individual optical fiber 342 (e.g., using vision alignment), and aligning the first end 312 of each tapered waveguide with respect to the alignment slot 324.

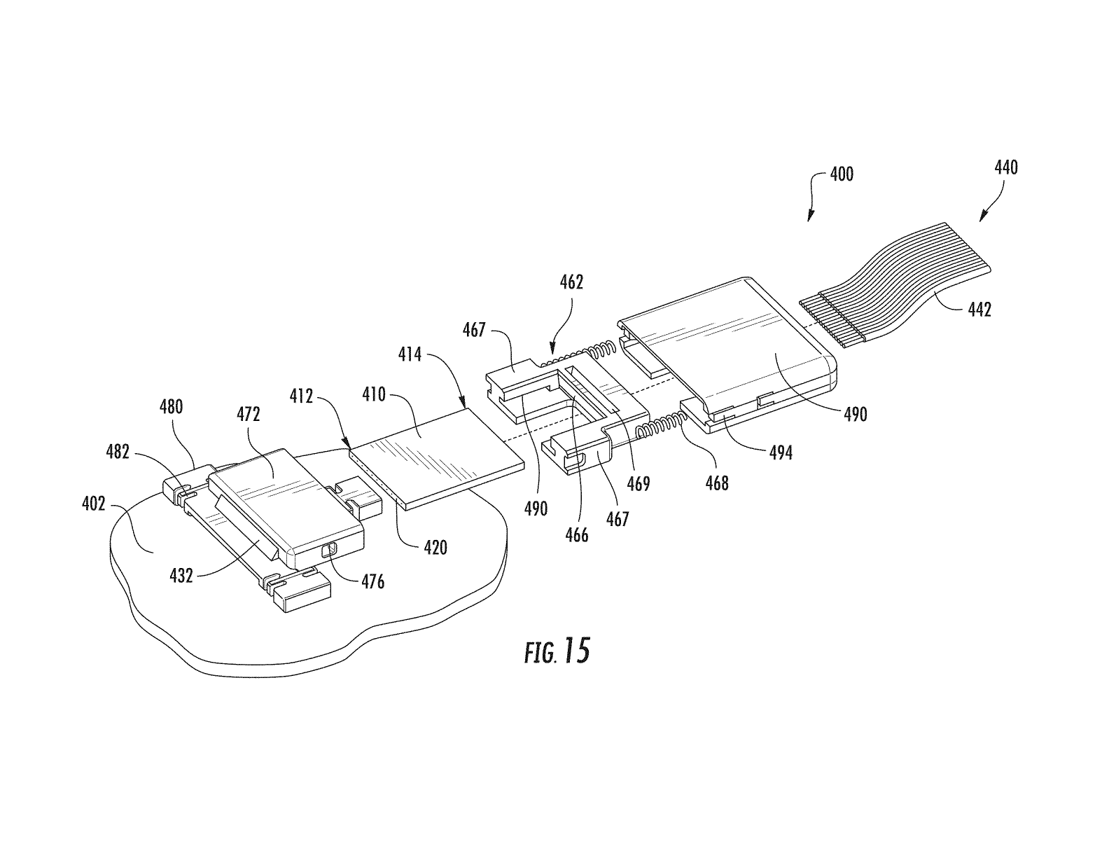

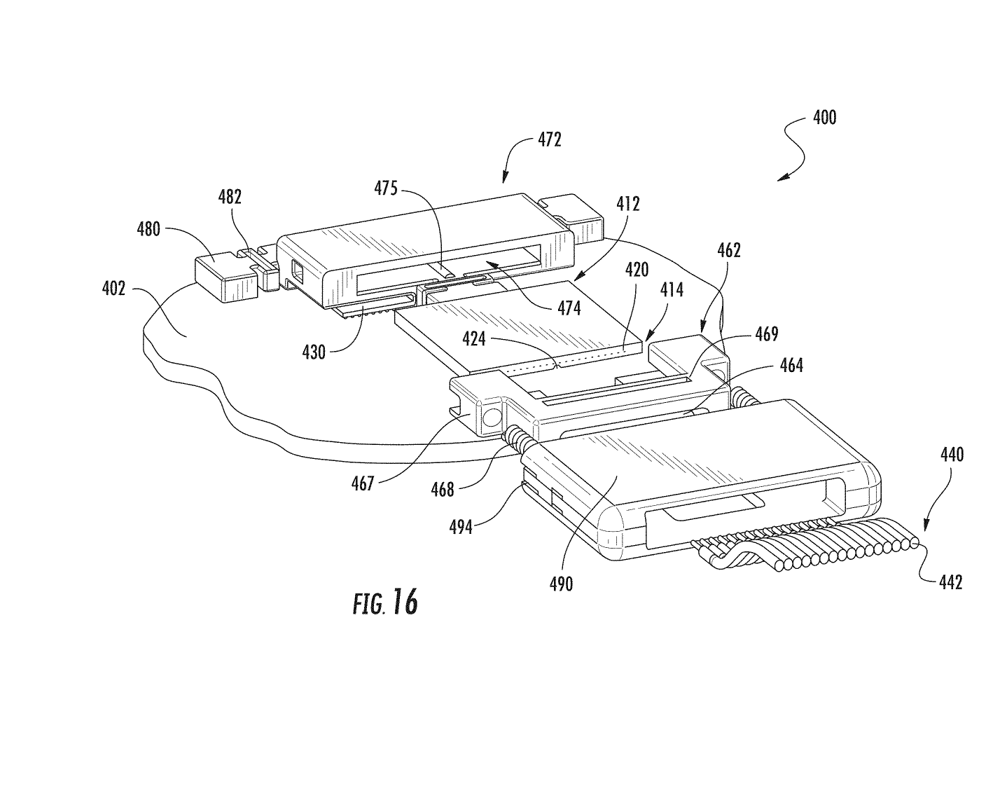

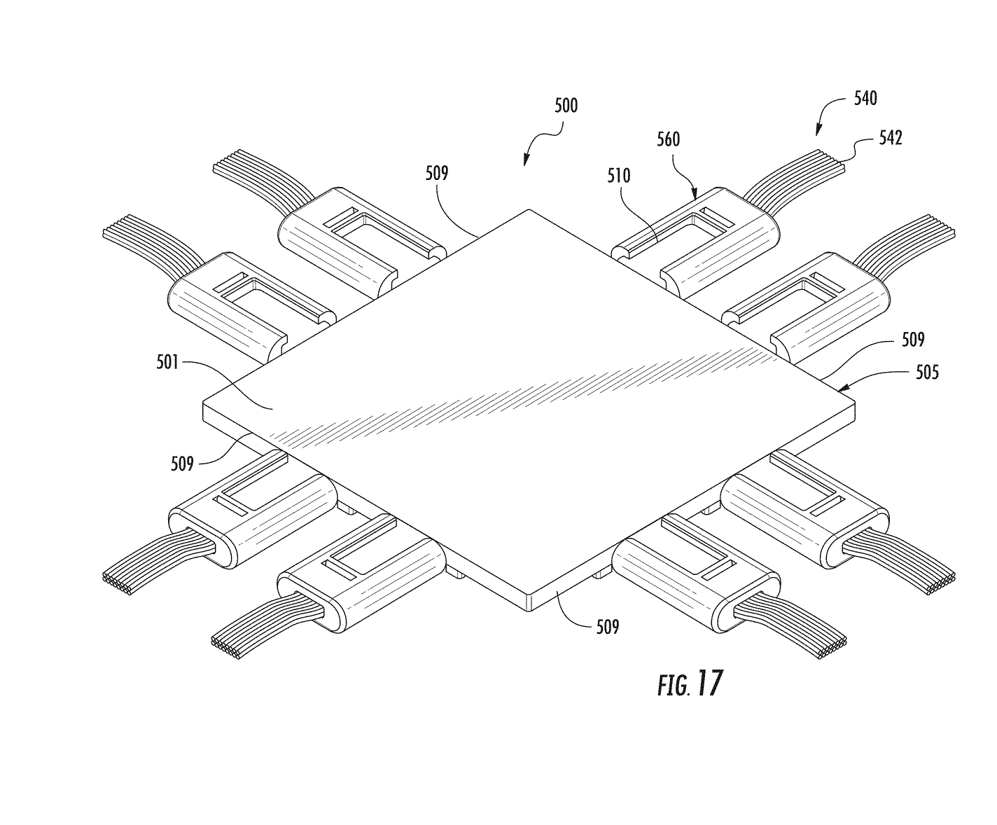

Referring now to FIGS. 14-16, another embodiment of a molded optical coupling 400 for a photonics circuit comprising a planar tapered waveguide coupling element 410 is depicted. It is noted that FIGS. 15 and 16 are exploded views of the molded optical coupling 400 depicted in FIG. 14. The planar tapered waveguide coupling element 410 may be configured as any of the planar tapered waveguide coupling elements 110, 110′, 210, 310 described above. The planar tapered waveguide coupling element 410 is positioned within a receptacle body 472 and/or a connector body 462 and optically couples an array of optical fibers 440 to a photonic integrated circuit (IC) 430 (FIG. 16), as described above with respect to the molded optical coupling 300. The molded optical coupling 400 of the illustrated embodiment further comprises a PCB 402. The receptacle body 472 and the photonics IC 430 may each be attached to the PCB 402. Further, in some embodiments, the photonics IC 430 may be communicatively coupled and/or optically coupled to the PCB 402, for example, the photonics IC 430 may be a component of the PCB 402.

Referring to FIG. 14 and to FIG. 15, the molded optical coupling 400 comprises the connector body 462, the receptacle body 472, and an outer connector 490. The connector body 462 may cooperate with the receptacle body 472 to house the planar tapered waveguide coupling element 410 and optically couple and optically align the array of optical fibers 440 with the photonics IC 430 (FIG. 16). Further, the outer connector 490 may cover the connector body 462 and engage the receptacle body 472. The first end 412 of the planar tapered waveguide coupling element 410 may be positioned within the receptacle body 472 and the second end 414 may be positioned within the connector body 462. As described above with respect to the connector body 362 and the receptacle body 372, the first end 412 may be optically coupled and optically aligned with the photonics IC 430 and the second end 414 may be optically coupled to the array of optical fibers 440.

Referring now to FIGS. 15-16, the connector body 462 includes a fiber receiving opening 464 that is sized and positioned such that the array of optical fibers 440 may extend through the fiber receiving opening 464 and be optically coupled to the planar tapered waveguide coupling element 410. For example, the array of optical fibers 440 may be precision cleaved and may abut the planar tapered waveguide coupling element 410. Further, the illustrated fiber receiving opening 464 includes a plurality of fiber coupling slots 466 each configured to hold an individual optical fiber 442 in optical engagement with an individual tapered waveguide 420 of the planar tapered waveguide coupling element 410. Further, in some embodiments, the connector body 462 may comprise a well 469 opening into the fiber receiving opening 464. The well 469 is sized and positioned such that the well 469 may receive a suitable adhesive (e.g., an optical adhesive) for securing the one or more optical fibers 440 to the connector body 462. It should be understood that the array of optical fibers 440 may comprise any exemplary optical fibers, such as, for example, single mode optical fiber, multimode optical fiber, single mode multi-core optical fiber, multimode multi-core optical fiber, or the like.

As depicted in FIGS. 15-16, the connector body 462 may include spring engaging shoulders 467 configured to receive a spring 468. In some embodiments, the spring engaging shoulders 467 may include a bore, for example, a blind bore sized and configured to house a portion of the spring 468. In some embodiments, the connector body 462 may comprise two spring engaging shoulders 467 engaged with two springs 468 positioned on opposite sides of the connector body 462. The springs 468 may extend between the spring engaging shoulders 467 and the outer connector 490. The spring engagement between the connector body 462 and the outer connector 490 may provide a floating engagement for the planar tapered waveguide coupling element 410. The springs 468 may bias the planar tapered waveguide coupling element 410 into a flush engagement with both the array of optical fibers 440 and the photonics IC 430. Additionally, the spring engagement may mechanically isolate the planar tapered waveguide coupling element 410 and reduce optical coupling error, for example, angular error between the planar tapered waveguide coupling element 410 and both the array of optical fibers 440 and the photonics IC 430.

Further, the receptacle body 472 comprises a substrate opening 474 configured to house a portion of the planar tapered waveguide coupling element 410, for example, the first end 412 as described above with respect to the molded optical coupling 300 (FIG. 16). The substrate opening 474 may comprise a centering rib 475 centrally located within the substrate opening 474. The centering rib 475 may be configured to engage an alignment slot 424 of the planar tapered waveguide coupling element 410 and provide the alignment functionality and benefits described above with respect to centering rib 375. Other alignment features and configurations may be utilized.

Referring still to FIGS. 15-16, the receptacle body 472 may be removably coupled to the connector body 462 and the outer connector 490. To facilitate this removable engagement, the example outer connector 490 comprises one or more outer connector latches 494 configured to engage with corresponding arm receiving slots 476 of the receptacle body 472. Further, the outer connector latches 494 may be inwardly biased such that the outer connector latches 494 may extend into the arm receiving slots 476 to hold the outer connector 490 in engagement with the receptacle body 472 and hold the connector body 462 between the outer connector 490 and the receptacle body 472. In some embodiments, the outer connector 490 comprises one outer connector latch 494 and, in other embodiments, the outer connector 490 comprises two outer connector latches 494, each positioned on a side of the outer connector 490, for example, opposite sides of the outer connector 490. It should be understood that any number of outer connector latches 494 are contemplated. Further, in some embodiments, additional outer connector latches 494 are configured to engage receiving slots of the connector body 462, for example, receiving slots positioned on the one or more spring engaging shoulders 467. It should also be understood that other means for providing removable engagement between the receptacle body 472, and outer connector 490, and the connector body 462 may be employed.

As depicted in FIGS. 14-15, the receptacle body 472 comprises a total internal reflection (TIR) structure 432 positioned such that the first end 412 of the planar tapered waveguide coupling element 410 is optically aligned with the TIR structure 432 when the planar tapered waveguide coupling element 410 is positioned within the substrate opening 474. In some embodiments, the TIR structure 432 may be the light source connector 270 described above with respect to FIG. 10. Further, the TIR structure 432 may comprise a molded TIR structure, for example a plastic such as polyimide (e.g., an EXTEM™ thermoplastic polyimide), or the like. In some embodiments, the TIR structure 432 may be coupled to the receptacle body 472 and, in other embodiments, the TIR structure 432 may be integral with the receptacle body 472.

Referring again to FIG. 16, the photonics IC 430 of the molded optical coupling 400 is communicatively coupled to the PCB 402 and optically coupled to the planar tapered waveguide coupling element 410 such that light emitted by the photonics IC 430 may be received by the array of optical fibers 440 and vice versa. Further, the photonics IC 430 may be optically coupled to the TIR structure 432 (for example, directly coupled to the photonics IC 430 and positioned above photonics IC 430) such that the TIR structure 432 optically couples the planar tapered waveguide coupling element 410 and the photonics IC 430. For example, the TIR structure 432 may be configured to turn the optical pathway to facilitate optical coupling when the lens array of the photonics IC 430 is not in direct alignment with the planar tapered waveguide coupling element 410, for example, when the photonics IC 430 is positioned substantially orthogonal the planar tapered waveguide coupling element 410.

In some embodiments, the receptacle body 472 and/or the outer connector 490 may be coupled to the PCB 402. The PCB 402 may comprise FR-4, AOC or any other embedded solution. In some embodiments, the receptacle body 472 and/or the outer connector 490 may be coupled to the PCB 402 using one or more bond pads 480 positioned between the outer connector 490 and/or the receptacle body 472 and the PCB 402. The bond pads 480 may comprise flexures 482 configured to expand and/or contract when an expanding or contracting force is applied to one or more of the components of the molded optical coupling 400, for example, the PCB 402, the receptacle body 472, the outer connector 490, the bond pads 480, or the like, as described above with respect to the molded optical coupling 300. Further, the molded optical coupling 400 may be fabricated using the laser printing methods described above with respect to the molded optical coupling 300. For example, the tapered waveguides 420 may be laser printed into the planar substrate 422 when the planar substrate 422 is positioned within the connector body 462.

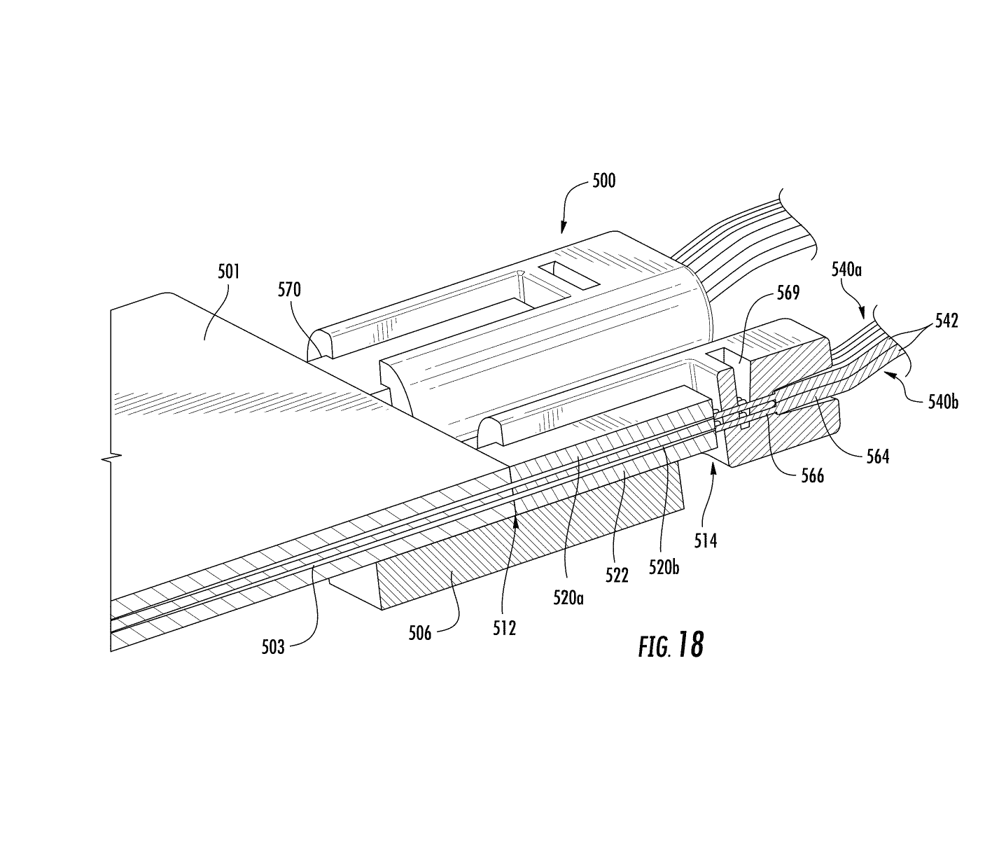

Referring now to FIGS. 17-18, an optical coupling 500 for a photonics circuit (i.e., an optical shuffle) comprising a plurality of planar tapered waveguide coupling elements 510 housed within a plurality of receptacle bodies 560 is depicted. The planar tapered waveguide coupling element 510 may be configured as any of the planar tapered waveguide coupling elements 110, 110′, 210, 310, and/or 410 described above. For example, each planar tapered waveguide coupling element 510 may comprise one or more arrays of tapered waveguides 520 positioned in a planar substrate 522. Each receptacle body 560 optically couples the individual planar tapered waveguide coupling element 510 with both a host glass 501 at a first end 512 of the individual planar tapered waveguide coupling element 510 and one or more arrays of optical fibers 540 at a second end 514 of the individual planar tapered waveguide coupling element 510. By coupling the larger, first end 512 of the array of tapered waveguides 520 to the host glass 501 (in particular, to one or more optical channels 503 positioned in the host glass), the allowable alignment offsets may be higher to facilitate easier coupling and installation.

The receptacle bodies 560 may be positioned around a perimeter 505 of the host glass 501 such that individual tapered waveguides 520 are optically coupled to individual optical channels 503 of the host glass 501. The optical coupling 500 may comprise any arrangement of receptacle bodies 560 optically coupled to the host glass 501. In some embodiments, each perimeter side 509 of the host glass 501 may be optically coupled to one, two, three, or more, receptacle bodies 560. For example, as depicted in FIG. 17, the host glass 501 is optically coupled to eight receptacle bodies 560 with two receptacle bodies 560 positioned at each perimeter side 509 of the host glass 501. Further, it should be understood that the in other embodiments, receptacle bodies 560 may be non-uniformly distributed around the perimeter 505 of the host glass 501.

As depicted in FIG. 18, each receptacle body 560 comprises one or more fiber receiving openings 564 sized and positioned such that one or more arrays of optical fibers 540 may extend through the fiber receiving opening 564 and be optically coupled to the planar tapered waveguide coupling element 520. For example, the one or more arrays of optical fibers 540 may be precision cleaved and may abut the planar tapered waveguide coupling element 510. Further, the fiber receiving opening 564 may comprise a plurality of fiber coupling slots 566 each configured to hold an individual optical fiber 542 in optical engagement with an individual tapered waveguide of the one or more arrays of tapered waveguides 520. Further, in some embodiments, the receptacle body 560 may comprise a well 569 opening into the fiber receiving opening 564. The well 569 may be sized and positioned such that the well 569 may receive a suitable adhesive (e.g., an optical adhesive) for securing the one or more arrays of optical fibers 540 to the receptacle body 560. It should be understood that the one or more arrays of optical fibers 540 may comprise any exemplary optical fibers, such as, for example, single mode optical fiber, multimode optical fiber, single mode multi-core optical fiber, multimode multi-core optical fiber, or the like.

Still referring to FIGS. 17-18, the receptacle body 560 further comprises one or more substrate slots 570 configured to engage the planar tapered waveguide coupling element 510 lengthwise along the planar tapered waveguide coupling element 510. The substrate slots 570 of the illustrated embodiment engage the planar tapered waveguide coupling element 510 from the first end 512, optically coupled to the host glass 501, to the second end 514, optically coupled with the one or more arrays of optical fibers 540. In some embodiments, the substrate slots 570 may be configured to engage the edges of the planar tapered waveguide coupling element 510 and in other embodiments, the substrate slots 570 may be configured to circumscribe the planar tapered waveguide coupling element 510.

The host glass 501 comprises a plurality of optical channels 503. The one or more receptacle bodies 560 are positioned about the perimeter 505 of the host glass 501 and hold the one or more planar tapered waveguide coupling elements 510 in optical alignment with the optical channels 503 of the host glass 501. Further, a plurality of joining elements 506 may be engaged with both the host glass 501 and an individual planar tapered waveguide coupling element 510, for example, using adhesive bonding including index matching optical path adhesive, UV bonding, or the like, to hold the individual planar tapered waveguide coupling element 510 in optical alignment with optical channels 503 of the host glass 501. The joining elements 506 may comprise any suitable material, for example, glass, plastic, or the like. The joining elements 506 may provide vertical alignment between the host glass 501 and the planar tapered waveguide coupling element 510. In some embodiments, the optical channels 503 may be tapered, for example, to match the waveguide diameter of the first end 512 of the tapered waveguides 520. The optical connection of the tapered waveguides 520 and the optical channels 503 provide little to no loss of port access, may minimize scrap produced during fabrication and during installation, and produce high assembly yields. Further, installation of the host glass 501 in optical engagement with the planar tapered waveguide coupling elements 510 may be faster than conventional fiber lay down methods for optical communications systems comprising multiple optical fibers.

Referring to FIG. 18, in some embodiments, the planar tapered waveguide coupling element 510 may comprise arrays of tapered waveguides 520 positioned in a stacked arrangement such that a first array of tapered waveguides 520a are positioned above a second array of tapered waveguides 520b. While FIG. 18 depicts a first and second array of tapered waveguides 520a, 520b, it should be understood that any number of arrays of tapered waveguides 520 may be positioned in a stacked arrangement within the planar tapered waveguide coupling element 510. These stacked arrays of tapered waveguides 520 may be configured to optically couple optical channels 503 of the host glass 501 at the first end 512 and optical fibers 540 at the second end 514. Further, the optical coupling 500 may be fabricated using the various laser printing methods described above.

Referring still to FIG. 17-18, the optical channels 503 of the host glass 501 may be optically coupled to one or more photonics IC each comprising a lens array such that light emitted by the one or more photonics IC may traverse the optical channels 503 of the host glass 501 and the tapered waveguides 520 of the planar tapered waveguide coupling elements 510 and may be received by the array of optical fibers 540. For example, in some embodiments, a central photonics IC may be optically coupled to the optical channels 503 of the host glass 501 such that some or all of the optical channels 503 are optically coupled the central photonics IC and some or all of the tapered waveguides 520 of the planar tapered waveguide coupling elements 510 the arrays of optical fibers 540 are optically coupled to the central photonics IC.

In alternative embodiments, any number of multiple photonics ICs may be optically coupled to the optical channels 503 of the host glass 501. For example, each planar tapered waveguide coupling element 510 may be optically coupled an individual photonics IC through the optical channels 503 of the host glass 501. In some embodiments, the optical coupling 500 may comprise multiple photonics ICs each optically coupled to one or more planar tapered waveguide coupling elements 510. Further, in each of these embodiments, the photonics IC may be optically coupled to the optical channels 503 using one or more TIR structures (for example, when the photonics IC is positioned substantially orthogonal to the optical channels 503. For example, the TIR structure may be configured to turn the optical pathway to facilitate optical coupling when the lens array of the photonics IC is not in direct alignment with the optical channels 503.

In some embodiments, the host glass 501 may be configured to provide fiber-to-fiber coupling between different individual optical fibers 542 positioned in optical engagement with the host glass 501. For example, the optical channels 503 may extend between different tapered waveguides 520 positioned in different planar tapered waveguide coupling elements 510 (or the same planar tapered waveguide coupling element 510). The optical channels 503 may have or more bending regions having bend radii. The bending regions turn the optical channels 503 to provide more flexible optical pathways between individual optical fibers 542. In some embodiments, the first array of tapered waveguides 520a may be configured provide an optical pathway for light output by the first array of optical fibers 540a and the second array of tapered waveguides 520b may be configured provide an optical pathway for light received by the second array of optical fibers 540b. In other embodiments, the first array of tapered waveguides 520a may be configured provide an optical pathway for light received by the first array of optical fibers 540a and the second array of tapered waveguides 520b may be configured provide an optical pathway for light output by a second array of optical fibers 540b. Further, any arrangement and combination of light outputting and light receiving optical fibers 542 and arrays of optical fibers 540 is contemplated.

It should now be understood that the optical couplings described herein employ a planar tapered waveguide coupling element to optically couple a light source and a receiving fiber. The planar tapered waveguide coupling element may be positioned along an optical pathway between the light source and the receiving fiber and may have a tapered shape to transition a light beam from a first beam size to a second beam size as the light beam traverses the planar tapered waveguide coupling element. Further, a lens system may be positioned within the optical pathway between the light source and the planar tapered waveguide coupling element and may collimate the light beam to align the light beam such that it can be linearly and angularly aligned with the tapered coupling element. While not intended to be limited by theory, the optical coupling may minimize both coupling loss and propagation loss of a light beam traversing between a light source and a receiving fiber. Additionally, the optical couplings may comprise various molded optical coupling assemblies that house a planar tapered waveguide coupling elements having an array of planar waveguides positioned within a planar substrate to optically couple an array of receiving fibers with a photonics integrated circuit, for example, a silicon photonics integrated circuit.

It is noted that the term “substantially” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. An optical coupling device comprising:
a planar tapered waveguide coupling element comprising a tapered waveguide positioned within a planar substrate having a first end opposite a second end, the tapered waveguide comprising a waveguide diameter that is larger at the first end than at the second end; and
an optical pathway located within the tapered waveguide and extending between the first end and the second end, wherein the tapered waveguide is tapered from the first end to the second end such that the waveguide diameter transitions a light beam traveling along the optical pathway from a first beam size at the first end to a second beam size at the second end.

2. The optical coupling device of claim 1, wherein the planar tapered waveguide coupling element comprises at least one additional tapered waveguide.

3. The optical coupling device of claim 1, wherein the tapered waveguide is one of an array of planar tapered waveguides.

4. The optical coupling device of claim 1, further comprising at least one additional planar tapered waveguide coupling element positioned in a stacked arrangement with respect to the planar tapered waveguide coupling element.

5. The optical coupling device of claim 1, wherein the tapered waveguide and the planar substrate each comprise a glass, a plastic, or a polymer, and the glass, plastic, or polymer of the tapered waveguide comprises a higher refractive index than the glass, plastic, or polymer of the planar substrate outside of the tapered waveguide.

6. The optical coupling device of claim 1, wherein the planar substrate comprises glass, and the tapered waveguide is fabricated into the planar substrate using an ion-exchange process.

7. The optical coupling device of claim 6, wherein the ion-exchange process comprises:
masking the planar substrate with a metal film
forming a taper pattern on the planar substrate using photolithography; and
placing the planar substrate having the taper pattern in a molten salt bath.

8. The optical coupling device of claim 7, wherein the molten salt bath comprises a KNO₃ molten salt bath or an AgNO₃ molten salt bath.

9. The optical coupling device of claim 1, wherein the tapered waveguide is fabricated into the planar substrate using a laser printing process.

10. The optical coupling device of claim 9, wherein the laser printing process comprises directing a laser pulse beam generated by a laser at the planar substrate to generate an index change within the planar substrate at a contact location between a focal point of the laser pulse beam and a portion of the planar substrate.

11. The optical coupling device of claim 10, wherein the index change is generated within the planar substrate using a two-photon absorption process.

12. The optical coupling device of claim 10, wherein the planar substrate is mounted on a motion stage structurally configured to provide motion such that the contact location between the focal point of the laser pulse beam and the portion of the planar substrate may be altered.

13. The optical coupling device of claim 11, wherein the laser comprises a femtosecond laser.

14. The optical coupling device of claim 11, wherein the laser pulse beam comprises a wavelength between about 700 nm to 1600 nm, a pulse rate between about 100 kHz to 1000 kHz, a pulse energy between about 1000 nJ and 5000 nJ, and a laser pulse width less than about 500 picoseconds.

15. The optical coupling device of claim 1, wherein:
the light beam at the first end of the planar tapered waveguide coupling element has one of one or more desired modes; and
the waveguide diameter transitions the light beam such that the light beam at the second end of the planar tapered waveguide coupling element is one of the one or more desired modes.

16. The optical coupling device of claim 1, wherein the waveguide diameter transitions the light beam such that a mode of the light beam at the second end of the planar tapered waveguide coupling element is the same as a mode of the light beam at the first end of the planar tapered waveguide coupling element.

17. The optical coupling device of claim 1, wherein a slope of the waveguide diameter of the tapered coupling element is determined by a relationship
$$\frac{dD}{dz} \leq \frac{D}{λ} ( {n}_{m} - {n}_{{m}^{′}} ) ,$$
where:
D is the waveguide diameter at a location along a length of the tapered coupling element;
λ is a wavelength of the light beam;
nₘ is an effective index of a first mode group;
n_{m′} is the effective index of a second mode group, and
z is the distance along the length of the planar tapered waveguide coupling element, wherein the first mode group and the second mode group comprise adjacent mode groups of the light beam at the location along the length of the planar tapered waveguide coupling element.

18. The optical coupling device of claim 1, wherein the waveguide diameter transitions the light beam along the optical pathway such that a propagation loss within the planar tapered waveguide coupling element is less than 1 dB.

19. An optical coupling for a photonics circuit, the optical coupling comprising:
a light source optically coupled a planar tapered waveguide coupling element, wherein the light source is configured to generate a light beam;
a lens system disposed within an optical pathway between the light source and the planar tapered waveguide coupling element, the planar tapered waveguide coupling element comprising:
a tapered waveguide positioned within a planar substrate having a first end opposite a second end, wherein the light source is optically coupled to the first end, the tapered waveguide comprising a waveguide diameter that is larger at the first end than at the second end; and
the optical pathway located within the tapered waveguide and extending between the first end and the second end, wherein the tapered waveguide is tapered from the first end to the second end such that the waveguide diameter transitions the light beam traveling along the optical pathway from a first beam size at the first end to a second beam size at the second end; and
a receiving fiber optically coupled to the second end of the planar tapered waveguide coupling element.

20. The optical coupling of claim 19, wherein the planar tapered waveguide coupling element comprises at least one additional tapered waveguide.

21. The optical coupling of claim 19, wherein the tapered waveguide is one of an array of planar tapered waveguides.

22. The optical coupling of claim 19, further comprising at least one additional planar tapered waveguide coupling element positioned in a stacked arrangement with respect to the planar tapered waveguide coupling element.

23. The optical coupling of claim 19, wherein the tapered waveguide and the planar substrate each comprise a glass, a plastic, or a polymer, and the glass, plastic, or polymer of the tapered waveguide comprises a higher refractive index than the glass, plastic, or polymer of the planar substrate outside of the tapered waveguide.

24. The optical coupling of claim 19, wherein an optical core diameter of the receiving fiber is substantially equivalent to the waveguide diameter at the second end of the planar tapered waveguide coupling element.

25. The optical coupling of claim 19, wherein the second end of the tapered coupling element is optically coupled to the receiving fiber by fusion coupling and/or index matching adhesive bonding.

26. The optical coupling of claim 19, wherein a slope of the waveguide diameter of the planar tapered waveguide coupling element is determined by a relationship
$$\frac{dD}{dz} \leq \frac{D}{λ} ( {n}_{m} - {n}_{{m}^{′}} ) ,$$
where:
D is the waveguide diameter at a location along a length of the planar tapered waveguide coupling element;
λ is a wavelength of the light beam;
nₘ is an effective index of a first mode group;
n_{m′} is the effective index of a second mode group, and
z is the distance along the length of the planar tapered waveguide coupling element, wherein the first mode group and the second mode group comprise adjacent mode groups of the light beam at the location along the length of the planar tapered waveguide coupling element.

27. The optical coupling of claim 19, wherein the waveguide diameter transitions the light beam along the optical pathway such that a propagation loss within the planar tapered waveguide coupling element is less than 1 dB.

28. An optical coupling for a photonics circuit, the optical coupling comprising:
a connector body; and
a planar tapered waveguide coupling element positioned within the connector body, the planar tapered waveguide coupling element comprising:
one or more tapered waveguides positioned within a planar substrate having a first end opposite a second end, the one or more tapered waveguides each comprising a waveguide diameter that is larger at the first end than at the second end; and
an optical pathway located within each of the one or more tapered waveguides and extending between the first end and the second end, wherein the one or more tapered waveguides are tapered from the first end to the second end such that each waveguide diameter transitions a light beam traveling along the optical pathway from a first beam size at the first end to a second beam size at the second end.

29. The optical coupling of claim 28, wherein the fiber receiving opening further comprises a plurality of fiber coupling slots each configured to hold and abut an individual optical fiber to an individual tapered waveguide of the planar tapered waveguide coupling element.

30. The optical coupling of claim 28, further comprising a receptacle body, wherein the receptacle body comprises a substrate opening configured to receive a portion of the planar tapered waveguide coupling element.

31. An optical coupling for a photonics circuit, the optical coupling comprising:
a host glass comprising a plurality of optical channels;
a plurality of receptacle bodies positioned around a perimeter of the host glass;
a plurality of planar tapered waveguide coupling elements housed within the plurality of receptacle bodies, each planar tapered waveguide coupling element comprising:
one or more tapered waveguides positioned within a planar substrate having a first end opposite a second end, the one or more tapered waveguides each comprising a waveguide diameter that is larger at the first end than at the second end; and
an optical pathway located within each of the one or more tapered waveguides and extending between the first end and the second end, wherein the one or more tapered waveguides are tapered from the first end to the second end such that each waveguide diameter transitions a light beam traveling along the optical pathway from a first beam size at the first end to a second beam size at the second end.

32. An optical coupling for a photonics circuit, the optical coupling comprising:
a light source connector comprising a light source housing and a light source disposed within the light source housing, wherein the light source is configured to generate a light beam;
a tapered coupling element connector comprising a tapered coupling element housing;
a planar tapered waveguide coupling element disposed within the tapered coupling element housing, the planar tapered waveguide coupling element comprising:
a tapered waveguide positioned within a planar substrate having a first end opposite a second end, the tapered waveguide comprising a waveguide diameter that is larger at the first end than at the second end; and
an optical pathway disposed within the tapered waveguide and extending between the first end and the second end, wherein the tapered waveguide is tapered from the first end to the second end such that the waveguide diameter transitions a light beam traveling along the optical pathway from a first beam size at the first end to a second beam size at the second end;
a lens system disposed within the optical pathway between the light source and the first end of the planar tapered waveguide coupling element; and
a receiving fiber connector comprising a receiving fiber housing and a receiving fiber disposed within the receiving fiber housing and optically coupled to the second end of the planar tapered waveguide coupling element.

33. The optical coupling of claim 32, wherein a slope of the waveguide diameter of the planar tapered waveguide coupling element is determined by a relationship
$$\frac{dD}{dz} \leq \frac{D}{λ} ( {n}_{m} - {n}_{{m}^{′}} ) ,$$
where:
D is the waveguide diameter at a location along a length of the planar tapered waveguide coupling element;
λ is a wavelength of the light beam;
nₘ is an effective index of a first mode group;
n_{m′} is the effective index of a second mode group, and
z is the distance along the length of the planar tapered waveguide coupling element, wherein the first mode group and the second mode group comprise adjacent mode groups of the light beam at the location along the length of the planar tapered waveguide coupling element.

34. A method of fabricating a planar tapered waveguide coupling element, the method comprising:
providing a planar substrate comprising a first end opposite a second end;
masking the planar substrate with a metal film;
forming a taper pattern on the planar substrate using photolithography; and
placing the planar substrate having the taper pattern in a molten salt bath such that one or more tapered waveguides are fabricated within the planar substrate, each tapered waveguide comprising a waveguide diameter that is tapered from a larger first end to a smaller second end.

35. A method of fabricating a planar tapered waveguide coupling element, the method comprising:
providing a planar substrate having a first end opposite a second end;
directing a laser pulse beam at the planar substrate to generate an index change within the planar substrate; and
providing relative motion between the laser pulse beam and the planar substrate such that the laser pulse beam moves between the first end and the second end of the planar substrate to form at least one tapered waveguide, wherein the at least one tapered waveguide comprises a waveguide diameter that is tapered from the first end to the second end, such that the first end of the at least one tapered waveguide is larger than the second end.

36. The method of claim 35, further comprising mounting the planar substrate on a motion stage structurally configured to provide motion such that the contact location between a focal point of the laser pulse beam and a portion of the planar substrate may be altered.

37. The method of claim 35, wherein the index change is generated within the planar substrate using a two-photon absorption process.

38. The method of claim 35, wherein a laser configured to output the laser pulse beam comprises a femtosecond laser.

39. The method of claim 35, wherein the laser pulse beam comprises a wavelength between about 700 nm to 1600 nm, a pulse rate between about 100 kHz to 1000 kHz, a pulse energy between about 1000 nJ and 5000 nJ, and a laser pulse width less than about 500 picoseconds.

40. The method of claim 35, further comprising:
coupling the second end of the planar substrate to at least one optical fibers before the one or more tapered waveguides are fabricated within the planar substrate; and
directing the laser pulse beam at a location of an interface between an end of the at least one optical fiber and the second end of the planar substrate; and
providing relative motion between the laser pulse beam and the planar substrate such that the laser pulse beam moves in a direction from the second end of the planar substrate toward the first end of the planar substrate to form at least one tapered waveguide that is aligned with the at least one optical fiber.

41. The method of claim 35, further comprising coupling the second end of the planar substrate to an array of optical fibers after the one or more tapered waveguides are fabricated within the planar substrate.

42. A method of assembling an optical coupling, the method comprising:
providing a connector body;
providing a planar substrate having a first end opposite a second end; and
positioning the second end of the planar substrate within the connector body;
coupling at least one optical fiber to the second end of the planar substrate; and
directing a laser pulse beam at a location of an interface between an end of the at least one optical fiber and the second end of the planar substrate to generate an index change within the planar substrate;
providing relative motion between the laser pulse beam and the planar substrate such that the laser pulse beam moves in a direction from the second end of the planar substrate toward the first end of the planar substrate to form at least one tapered waveguide that is aligned with the at least one optical fiber, wherein the at least one tapered waveguide comprises a waveguide diameter that is tapered from the first end to the second end, such that the first end of the at least one tapered waveguide is larger than the second end.

43. A method of assembling an optical coupling for a photonics circuit, the method comprising:
providing a connector body and a receptacle body;
providing a planar tapered waveguide coupling element comprising a planar substrate having a first end opposite a second end and one or more tapered waveguides positioned within the planar substrate, each tapered waveguide comprising a waveguide diameter that is larger at the first end than at the second end;
positioning the second end of the planar substrate within the connector body;
coupling the second end of the planar substrate to at least one optical fiber;
positioning the first end of the planar substrate within the receptacle body; and
optically aligning the first end with a photonics integrated circuit configured to output a light beam.
